(19) United States
(12) Patent Application Publication
(10) Pub. No.: US 2009/0006226 A1
(43) Pub. Date: Jan. 1, 2009

(54) Stock analyzing engine

(75) Inventor: William Rory Crowder, Malibu, CA (US)

Correspondence Address: Leon E. Jew;The Schinner Law Group, 96 Jessie Street, San Francsico, CA, 94105, US

(73) Assignee: Change Point Analytics Ltd

(21) Appl. No.: 12/080,681

(22) Filed: Apr. 4, 2008

Related U.S. Application Data
(60) Provisional application No. 60/937,665, filed on Jun. 29, 2007.

(51) Int. Cl. G06Q 40/00; G06Q 10/00

(52) U.S. Cl. 705/30; 705/36 R

(57) ABSTRACT

A computer implemented system and method for providing intuitive graphs depicting stock market performance over a computer network, the system comprising: at least one database maintaining separately stored fundamental data for each publicly traded company, a server computer communicatively coupled to the database and accessible via client computers to a plurality of users, a user's graphical interface from which the user enters a request to and receives a response from the server computer, and a processor for processing the user's request and delivering the response to the user. The fundamental data for each publicly traded company is calculated, stored and expressed in daily, weekly, monthly, quarterly and annual incremental periods as required by the user. The response includes graphs depicting interrelated progression of stock movement and primary and secondary corporate operating fundamentals and performance statistics.

### REFERENCE TO RELATED APPLICATION

The present application claims benefit of prior filed provisional Appl. Ser. No. 60/937,665 filed on Jun. 29, 2007, the entire content of which is hereby incorporated by reference.

### COPYRIGHT NOTICE

Contained herein is material that is subject to copyright protection. The copyright owner has no objection to the facsimile reproduction of the patent disclosure by any person as it appears in the U.S. Patent and Trademark Office patent files or records, but otherwise reserves all rights to the copyright whatsoever.

### FIELD OF THE INVENTION

The present invention relates in general to data processing and securities analysis illustration, more particularly, related to a powerful leap forward˜a new genre relational data software illustration system to visualize and correlate stock performance, fundamental fair market value characteristics and business operating trends for individual companies, investment portfolios, indexes and mutual funds.

### BACKGROUND OF THE INVENTION

Since the 1930's, the Securities Exchange Commission (SEC) has mandated and enforced continuing to evolve standards of accounting and requirements of full disclosure plus appropriate discussion of all material opportunity and liability themes, which companies that issue publicly traded stock are required to report and make readily available to the public.

Prior to the Internet age, as a result of owning exclusive access to trading on every stock exchange, major Wall Street brokerage firms had also achieved the de-facto status of “exclusive gatekeepers” of distributing credible financial information, and were able to charge premium prices for value added research services, and maintain substantial profit margins in the process of transacting on behalf of the entire financial marketplace.

However, widespread computerization and the new math of exponential Internet economics have fueled a quantum increase in the quantity of competing investment data and historical background information, which is now commonly available at no charge to every investor via numerous Internet sources.

At the same time, a wide variety of online brokerage firms have offered dramatically reduced brokerage transaction costs, and fees have dropped to as little as $10.00 per trade via various increasingly well established Internet based discount brokerage firms. In response, traditional commission based Wall Street brokerage firms have scrambled to cut operating expenses in a steeply declining revenue per transaction marketplace. The fallout at major Wall Street based retail brokerage firms has been a decline in services offered; an industry wide reduction in support services staff; and a substantially reduced offering of in-house research featuring in-depth coverage of industry groups and individual company stocks.

In the interim period of a changing of the guard, there is always a mismatch and lag in practical services offered. Online news and information sources have stepped into the vacuum of receding brokerage firm coverage, and have continued to multiply and add breadth to the quality and quantity of information resources and data being distributed to the retail public.

Increased technology offerings by online brokerage firms, the emergence of media investment channels, and improving on-line access to news, investment tools, stock graphics and research opinion, offer the retail public a more complete fundamental evaluation approach to investing by introducing, explaining and reporting an increasing number of investment variables.

However, the unmet desires of retail investors as they experience the chatter of media coverage and explore virtual database sources of academic information reveals the limitations and deficiencies of what is currently being offered.

To satisfy disclosure requirements and to help support the favorable currency value of the company's stock, publicly held companies hold annual meetings, publish quarterly 10Q and Annual 10K reports per prescribed accounting and financial information presentation standards, issue press releases, meet with analysts, and are regularly interviewed by the financial press.

Corporate executives give speeches, develop and present employee stock and stock option award compensation packages; identify and pursue new technology, key employee and merger and acquisition candidates; plan and transact the spin off or write down of existing assets; formulate internal new business development strategies; conduct institutional “road shows”; and are obligated to perform in a fiduciary capacity to manage the expectations of financial news services, the brokerage industry and the investing public regarding the progression of trends which affect the business environment in which they operate.

Obviously there is a lot going on behind the scenes that the public wants to know about. From a practical standpoint however, it has only been since the advent of the Internet age that the investing public at large has enjoyed the opportunity of convenient and timely access to even a small part of these “official acts of fiduciary responsibility and public disclosure”.

The unexplored terrain of opportunity is that experienced and inexperienced investors desire new and profoundly better sources of information. More specifically, without getting lost in detail they want to get a more comprehensive and intuitive view of the inner workings of whatever companies, core and emerging products, evolving technologies and developing industry trends they have an interest in.

They desire increased levels of content which is displayed in graphic formats they can make sense of in educating themselves to form their own opinion and make their own decisions. In a word, investors seek independence in the investment decision making process.

It is common knowledge in investment banking circles and as any business owner can tell you, the visible footprint of the vibrancy and health of a business begins with a review of the balance sheet and income statements.

In the case of publicly held companies, an exhaustive level of balance sheet and fundamental operating data is available to the public via company issued quarterly and annual 10K and 10Q reports, much of which is also illustrated in summary form all over the Internet.

However, as a carry-over influence from the previous dominance of large Wall Street Brokerage firms, the continuing industry wide protocol of formatting balance and income sheet information in “Database Table Formats” accompanied by simple graphic representations of a few basic investment variables, has made the task of evaluating raw data difficult and time consuming.

Most people's brains simply don't work that way.

The public is clearly interested in the essential elements of the information, and yet, an overwhelming percentage of people are disoriented, unzipped and bewildered by the style of presentation of the data.

Even if they understood how to do it, it is a tedious and daunting challenge to manually sift through tabular data, and identify emerging trends and cause and effect relationships within the context of evolving market change.

They need the information to be wrapped in a consumable package.

To make sense of the data, what investors actually need is an effective representation of a far more comprehensive data package (the major elements of the balance sheet and income statements), which are arrayed in intuitive graphic formats in such a way as to enable the user to superimpose and compare the progression of combinations of fundamental data (i.e. net income, revenue, debt and debt coverage levels, earnings per share, cash flow, profit margins, total equity, and various forms of capitalization and operating ratios, etc), and also be able to superimpose and easily compared these factors with stock price movement and stock performance analytics within the same graph, over the same time period.

Prior to the present invention, this type of intuitive high level analysis has never been available in the marketplace. Because of perceived, stated and presumed difficulties combining the functions and utility of creating and updating massive quantities of data contained in combinations of multiply linked databases; deriving, phasing and unifying data to a common scale and time period; and perceived limitations of usefulness and deficiencies in the potential of current state of the art graphic design formats applicable to illustrating stocks, mutual funds and indexes; obvious non trivial logistical issues have needed to be overcome to achieve a new state of the art in securities analysis illustration.

The object of this invention is to provide a new higher function phased database STOCKALIZER Engine which is designed to automate the process of data collection, synthesis and analysis of multiple array fundamental and technical stock market cross linked databases; and to act as a host controller to unify and distribute the linked graphic engine applications needed to illustrate new genre Stockalizer Series; Stockatron Universe Comparison Graphs; Stockatron Index, Mutual Fund and Synthetic Security Synthesizer Series; and Stockalizer Portfolio tools and Pattern Recognition Stock Analysis Graphs for PC, network and internet distribution.

### BRIEF DESCRIPTION OF DRAWINGS AND CHARTS

For a more succinct understanding of the nature and objects of the present invention, reference should be directed to the following detailed description taken in connection with the accompanying drawings in which:

FIG. 1A is a schematic diagram illustrating the system and method for providing Internet based service of graphical illustrations on stock market according to the present invention;

FIG. 1B is a schematic block diagram illustrating the essential steps of the method according to the system of FIG. 1A;

FIG. 2 is a schematic block diagram illustrating the computer environment for the system and method according to the invention.

FIG. 3 is a schematic block diagram illustrating the stock performance analysis application running on a local computer according to one preferred embodiment of this invention;

FIG. 4 is a schematic flow diagram illustrating the basic steps for the operations according to FIG. 3;

FIG. 5 is a schematic block diagram illustrating the operations for graphical presentation of stock analysis via a service provider's website according to FIG. 1A;

FIG. 6 is a block diagram illustrating the system for presenting the pattern recognition graphs of stock performance analysis for company specific historical data according to one preferred embodiment of the invention;

FIG. 7 is a flow diagram illustrating the method for presenting the pattern recognition graphs of stock performance analysis on company specific historical data according to one preferred embodiment of the invention;

FIG. 8 is a flow diagram illustrating the method for presenting the pattern recognition graphs of stock performance analysis on historical data of all companies according to one preferred embodiment of the invention;

FIG. 9 is a flow diagram illustrating the method for presenting the pattern recognition graphs of stock performance analysis via a computer network such as the Internet according to one preferred embodiment of the invention;

FIG. 10 is a typical graphical presentation of a single company or synthetically combined net portfolio summary of a 90 Day, 180 Day and 365 Day Historical Price Performance graph, juxtaposed with the progression of the Price Earnings Multiple (PE) and Growth Rate (EPS+Revenue) as illustrated within a single graph over a one year period (Stockalizer Portfolio˜Trend Analysis);

FIG. 11 is a typical graphical presentation of Historical Price˜Open, High, Low, Close Color Coded Box Graph with two moving averages (Daily Price Graph);

FIG. 12 is a typical graphical presentation of cumulative stock performance over time superimposed with a variety of cumulative measures of operating and balance sheet variables—cumulative growth from 1995 to 2007 (The Stockalizer);

FIG. 13 is a typical graphical presentation of stock performance superimposed with a variety of operating and balance sheet variables on a year over year comparison basis—Year-over-Year Quarterly Rates of Change from 1995 to 2007 (The CycleGraph);

FIG. 14 is a typical graphical presentation of a company's stock performance superimposed with a variety of current, trailing and forward looking performance, operating and balance sheet variables—evolving tread analysis from 2000-2007 (CycleAnalytics);

FIG. 15 is a typical graphical presentation of long term year over year patterns of price performance for individual stocks and major market indexes—1947-2007 S&P 500 market cycle (The Market CycleGraph);

FIG. 15A is a typical chart presentation illustrating and describing details of the repeating history of full market cycles (Anatomy of a Full Market Cycle);

FIG. 16 is a typical graphical presentation of compound rate of growth comparisons of price movement, valuation and operating variables graph 2000-2007 (Compound DataTron);

FIG. 17 is a typical graphical comparison presentation of dynamic range of movement of stock performance, and price movement correlations to industry groups and market indexes, valuation measures and operating variables (Momentum Matrix˜2000-2007”);

FIGS. 18-21 illustrates an example of a typical graphical presentation of an automated composite four page summary report including text boxes, proprietary data tables and combinations of “Stockalizer Series” illustrations arranged in a preformatted company specific multi-page summary report format (The Stockalizer Report);

FIG. 22 is a typical graphical presentation for the universe of stocks spreadsheet summary (Stockatron Universe Summary);

FIG. 23 is a typical graphical presentation of an in-depth company specific snapshot summary page of a universe of investment and performance measures (Stockatron Analytics˜Company Snapshot);

FIG. 24 is a typical graphical presentation of a company specific dual axis scattergram illustration comparison of combinations of key variable measures (Stockatron Company Profile);

FIGS. 25-29 are five typical graphical presentations of pre-selected combinations of key variables contained in the Stockatron database for a universe of companies (Stockatron Constellation Charts);

FIGS. 25-29, 30 are typical graphical examples of an innovative new custom data-point indicator which employs stock symbols, names or variables as dot points (Stockatron Constellation Charts & Portfolio Management Tools);

FIG. 31 is a typical graphical presentation which illustrates synthetically combined cumulative price performance data for the composite collection of companies contained in indexes, mutual funds and synthetic securities when superimposed over the composite cumulative growth of a variety of operating and balance sheet variables over the same time period (The Stockatron Universe˜A Virtual Tour Of Indexes & Mutual Funds);

FIG. 32 is a typical graphical presentation of one of the already described “Stockatron Universe Constellation” series of formatted data graphs which are also available to measure and correlate the performance and valuation measures of combinations of mutual funds, indexes or portfolios, or to illustrate the relationship and correlation of the individual component pieces of mutual funds and index components, to be illustrated within the “Stockatron Universe Constellation” comparison chart format series (Stockatron Mutual Fund Analyzer);

FIG. 33 is a typical graphical presentation of the cumulative composite performance of an investor's portfolio or any synthetic combination of securities, when compared to major market indexes, industry groups, managed accounts, etc . . . as measured on an intraday, daily, weekly, monthly, quarterly, semi-annual, annual, multi year and other variable time period basis (Stockalizer Portfolio Comparison to Major Market Indexes);

FIG. 34 is a typical graphical presentation of the cumulative growth of stock prices of the pro-rata composite of companies contained in an investor's portfolio superimposed with the cumulative growth of pro-rata operating and balance sheet variables over the same time period (The Stockalizer—Cumulative Growth Rates 2000-2007);

FIG. 35 is a typical graphical presentation of the YOY quarterly rates of change for the composite mix of companies held in an investor's portfolio when superimposed with a variety of composite operating and balance sheet variables on a Year over Year comparison basis (CycleGraph˜YOY Quarterly Rates of Change 1995-2007);

FIG. 36 is a typical graphical presentation of the stock performance of a composite pro-rata percentage mix of companies held in an investor's portfolio when superimposed with a variety of current, trailing and forward looking composite performance, operating and balance sheet variables—evolving trend analysis from 2000-2007 (CycleAnalytics˜Evolving Trend Analysis);

FIG. 37 is a typical graphical presentation of the composite pro-rata percentage mix of companies held in an investor's portfolio when measured for a continuous compound rate of growth comparison of composite price movement, valuation and operating variables—a compound rate of growth graph for 2000-2007 (Compound DataTron˜Compound Rates of Growth);

FIG. 38 is a typical graphical presentation of the composite pro-rata percentage mix of companies held in an investor's portfolio, when measured for continuous dynamic range of movement of stock performance, and price movement correlations to industry groups and market indexes, composite valuation measures and operating variables (Momentum Matrix˜2000-2007).

### DESCRIPTION OF THE INVENTION

This invention provides a system and method which enables investors to easily visualize and compare the relationship of stock price movement and the underlying progression of fundamental operating variables of companies listed on exchanges around the world. The system includes an application, called STOCKALIZER engine, for illustration and securities analysis, at least four databases, and various applications which enable on-line implementations.

In this application, STOCKALIZER, STOCKATRON, STOCKATRON UNIVERSE, STOCKATRON CONSTELLATION variable comparison graphs, STOCKATRON MUTUAL FUND ANALYZER, STOCKATRON INDEX ANALYZER, and STOCKALIZER PORTFOLIO tools are proprietary trademarks or/and service marks.

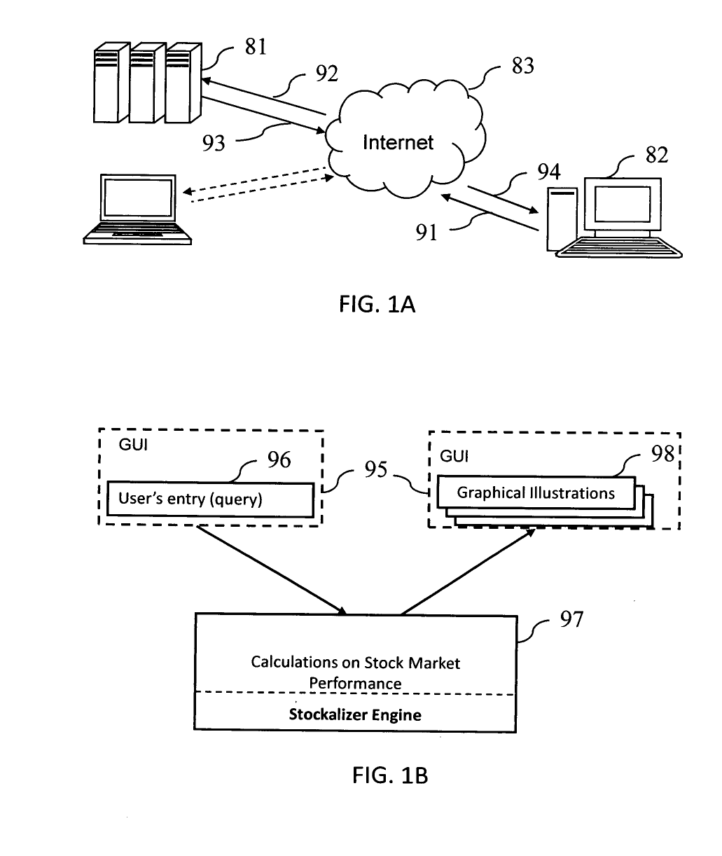

FIG. 1A is a schematic diagram illustrating the system and method for providing an Internet based service of graphical illustrations on stock market according to the present invention. The system includes a server computer 81 and at least one client computer 82, both of which are communicatively coupled to the Internet 83. A user may access the server computer 81 from the client computer 82 via the Internet 83. From a graphical user interface (GUI) accessible at the client computer 82, the user may log on the service application of the server computer 81 via the Internet 83. The data flow of the operation includes:

Step 91: Upon user's entering a query for the service offered, the client computer 82 directs the data packet of the query to the Internet 83;

Step 92: The data packet of the query is further directed to the server computer 81;

Step 93: Upon processing the query, the server computer 81 directs the data packet of the response to the Internet 83;

Step 94: The data packet of the response is further directed to the client computer 82.

FIG. 1B is a schematic block diagram illustrating the essential steps of the method according to the system of FIG. 1A. From the GUI 95, the user enters a query 96 to the STOCKALIZER Engine Application 97 which calculates the stock market performance according to the query 96 and returns to the user the response to the query with a number of graphical illustrations 98. The STOCKALIZER Engine Application may run on a non-networked computer or runs cross the Internet on any networked computer which is communicatively coupled to the server computer via the Internet.

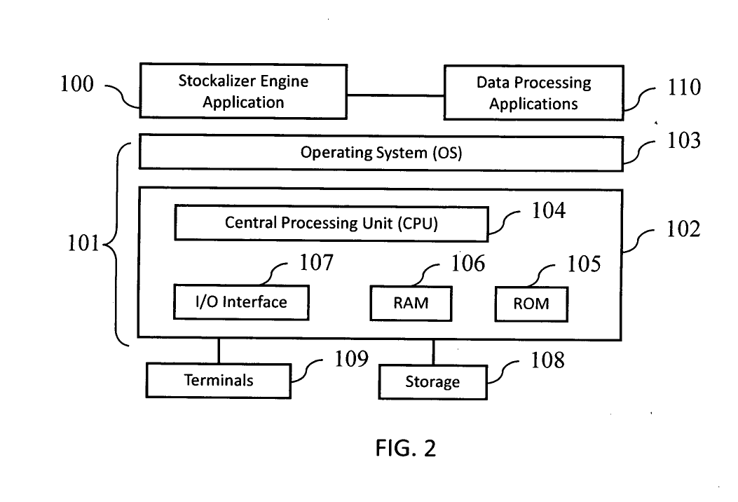

FIG. 2 is a schematic block diagram illustrating a computer environment wherein the preferred embodiment of this invention operates. The computer environment includes a computer platform 101 which includes a hardware unit 102 and an operating system 103. The hardware unit 102 includes at least one central processing unit (CPU) 104, a read only random access memory (usually called ROM) 105 for storing application programs, a write/read random access memory (usually called RAM) 106 available for the application programs' operations, and an input/output (IO) interface 107. Various peripheral components are connected to the computer platform 101, such as a data storage device 108 and a terminal 109. A stock performance analysis application 100, i.e. the STOCKALIZER Engine, adapted to a data processing application 110, such as Microsoft Excel, or a standalone custom data processing application program which runs on the computer platform 101. Those skilled in the art will readily understand that the invention may be implemented within other systems without fundamental changes.

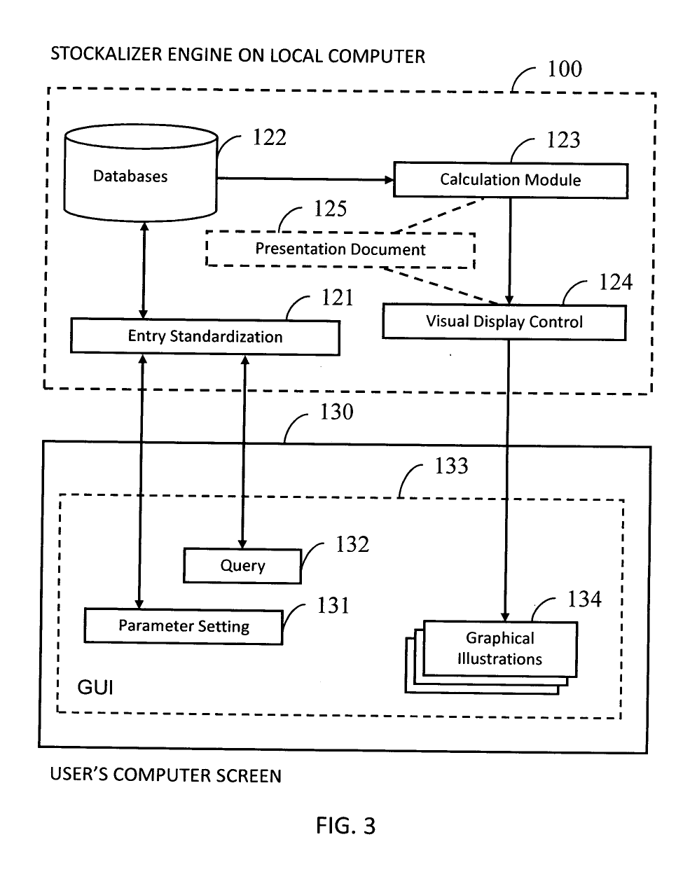

FIG. 3 is a schematic block diagram illustrating one preferred embodiment of the present invention. The STOCKALIZER Engine application 100 is incorporated in a data processing application which supports visual presentation documents such as Microsoft Excel, or operates as a stand alone data processing engine which interfaces and drives a separate stand alone custom graphical engine. A user who opens a document 125 may conduct an analysis via a graphical user interface (GUI) 133 displayed on the user's screen 130. The user uses a parameter setting means 131 to set a number of parameters from a number of choices such as income and balance sheet data, forward estimates, historical price movement and the like. The parameter setting means 131 can be a dropdown list or a number of hyperlinked icons, each of which represents an option. The system can be configured to enable the user to choose several options at the same time. The default parameters can be preset but they can be re-set by the user. The default parameter settings can be configured as the parameter settings that the user used last time. In that case, the user does not need to set parameters every time when he activates the STOCKALIZER application. The entry standardization module 121 is a program which is powerful enough to screen, analyze, and transform a non-common use query, such as a company's full name etc., into a standardized query, i.e. an official symbol for a stock. After a standardized entry is determined, the system looks up to the databases 122 which include a number of rules of extracting data. Then, the system determines the scope of variables to be chosen. The calculation module 123 makes calculations and organizes the calculation results according to the format requirements of the presentation document 125. Via the visual display control 124, the presentation document is returned to the user and displayed as graphics 134. Note that the entry standardization 121 is optional. In certain implementations, it is not necessary.

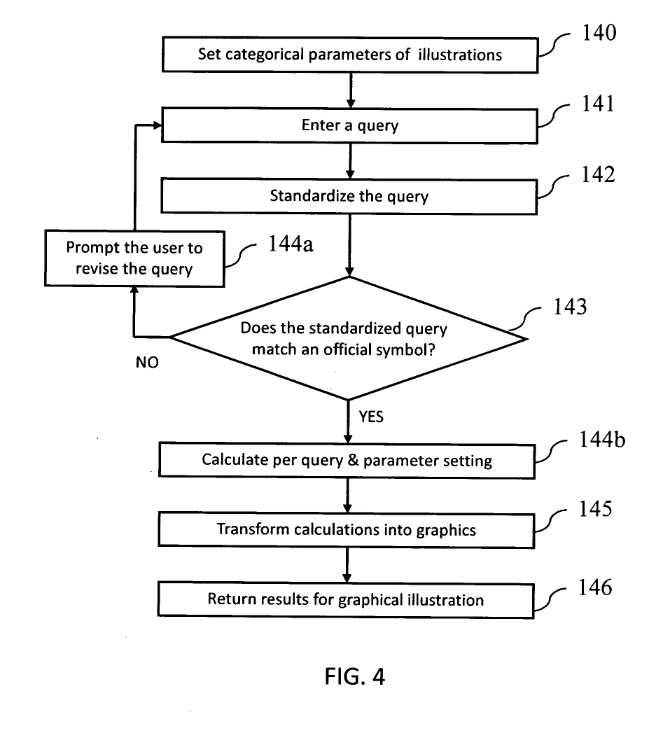

FIG. 4 is a schematic flow diagram illustrating a method according the preferred embodiment of FIG. 3. The method includes the steps of:

Step 140: The user sets categorical parameters of graphical illustrations, such as choosing a stock market.

Step 141: The user enters a query, such as a company's name or a stock symbol.

Step 142: The system conducts a primary standardization on the query, i.e. standardize the query in accordance with the official list of stock symbols.

Step 143: The system tries to match the standardized query to a categorically unique symbol in the databases.

Step 144a: If the standardized query fails to match a symbol in the database, the user will be prompted to revise the query.

Step 144b: If the standardized query does match a symbol in the databases, the system performs calculations in accordance with the parameters set and the query entered.

Step 145: The system transforms the calculation results into a document for graphics presentation.

Step 146: The system returns the calculation results for graphical illustrations.

The STOCKALIZER Engine and the related applications can be implemented and installed in a website's server. Upon entering the website's main page, the user may login the system and enter his query via a graphical user interface (GUI) as illustrated in FIG. 2 and FIG. 4.

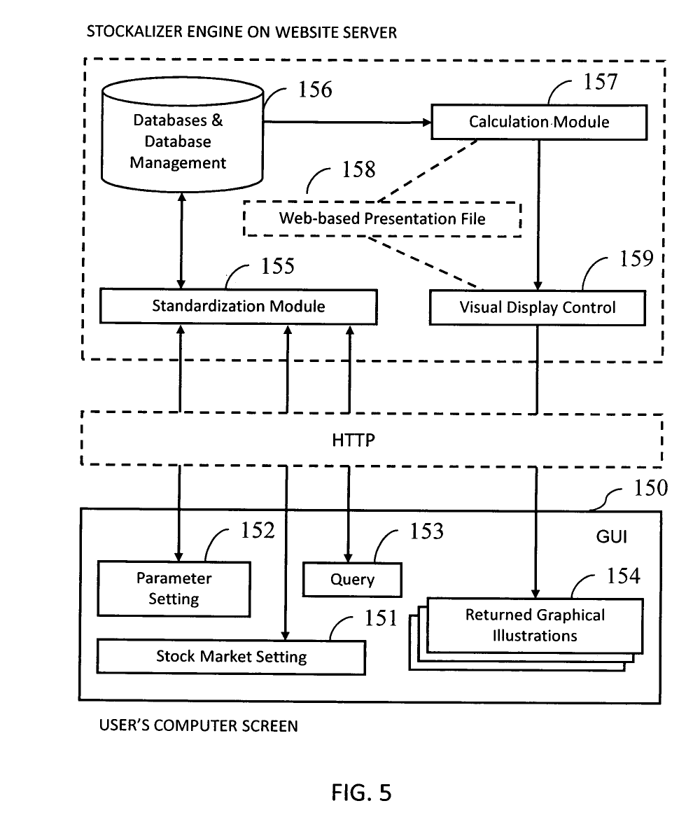

FIG. 5 is a schematic block diagram illustrating the operations for graphical presentation of stock analysis via a service provider's website according to FIG. 1A. Before the user initiates a task, he may set the stock market 151 and set the graphical presentation parameters 152 in the user's interface 150. The user then enters a keyword, a company's name or a stock symbol as query 153. When he initiates the task by a start command, such as by clicking a “GO” button or a similar icon, the query is sent to the entry standardization module 155, which is a component of the system's software application. The standardization module 155 first standardizes the query based on a number of rules in connection with the selected stock market, and then looks up the databases 156 to match the standardized query to an officially listed stock symbol. If it does not match an official symbol, the user will be prompted to revise the entry until the matching is successful. Then, in accordance with the selected parameters, the standardization module 155, along with the databases 156 and the associated applications, reports all or some relevant data to the calculation module 157, which is a component of the system's software application for calculating the stock performance according to a set of algorithms. Then, the calculation module 157 returns the graphical presentation file 158 to the user via the visual display control 159 and the user's interface 150.

The following samples illustrate the use of a newly developed information and visualization tool, the Change Point Analytics STOCKALIZER, which is an automatically updated multi page report and series of independent illustrations which graphically illustrates the evolution and progression of the ongoing relationship between financial statement operating variables and stock price performance.

By virtue of new algorithms we have developed to derive custom data, our proprietary array of financial database information, our work to advance the art of solving financial data phasing and scaling issues, and our own advancement of the art and substantial intellectual property development of new pattern recognition graphic illustration formats which are specifically designed to create a new level of intuitive securities analysis, the Change Point Analytics STOCKALIZER Program is designed to assist people in their self-education at much higher information levels and substantially faster recognition times than has been previously possible.

The STOCKALIZER allows the user to easily view the new higher level of expression of information they need to evaluate the ongoing evolution of companies, industry groups, and different styles and strategies of decision making in their investment portfolio. The program is easy to use. By simply typing in the stock symbol from the graphical user interface (GUI), within seconds the user can produce a suite of custom visualizations for virtually any company or combination of companies that he may have an interest in.

The visual presentation means according to this invention includes a set of STOCKALIZER Series Visualization Charts, which is a substantial first in the financial industry, an important “advancement of the art” new array of financial market data specific, highly intuitive and specially designed graphic formats which allow the user for the first time to superimpose and compare the progression of combinations of key fundamental, technical and relative value data right along with stock price movement and performance analytics over the same time period.

By virtue of solving previously unsolved database phasing, data synthesis, scaling and custom illustration format design issues, the casual investor with no previous experience or special expertise can rapidly acquire ultra fast “Pattern Recognition” intuitive fundamental analysis skills, while a sophisticated investor can use the STOCKALIZER to visualize at a glance the appearance and interrelationships of operating fundamentals superimposed with ratios, valuation measures, technical indicators and continuously evolving price movement performance.

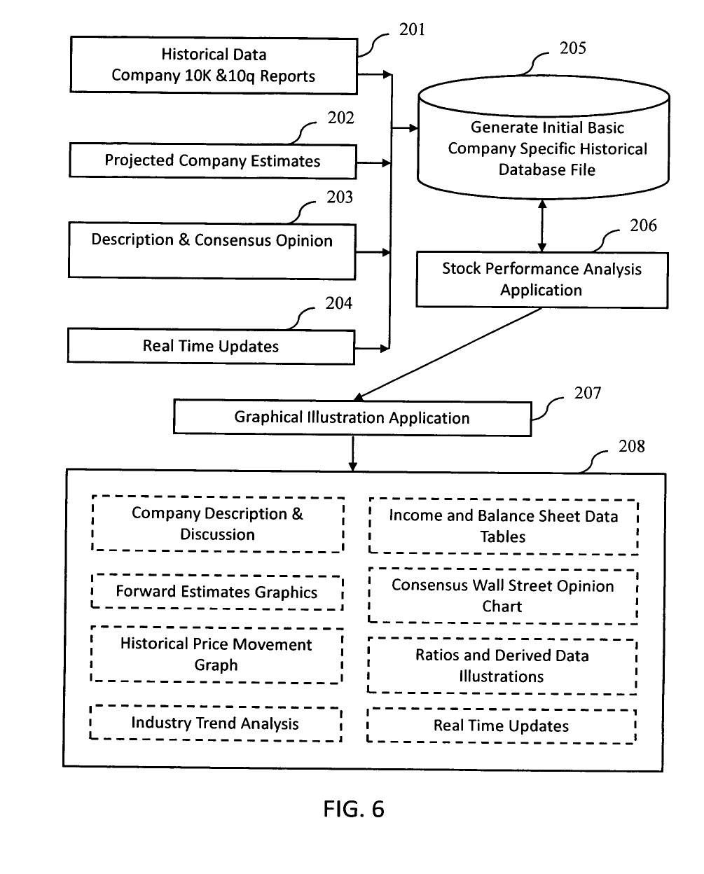

FIG. 6 is a block diagram illustrating the system for presenting the “Pattern Recognition” graphs of stock performance analysis for company specific historical data. The system extracts the historical data from a company's annual 10K and quarterly 10q reports 201, the projected company estimates 202, the description and consensus opinion 203 and the real time updates 204 and integrates the data into the databases which generate initial basic company specific historical database file 205. The stock performance analysis application 206, together with the graphical illustration application 207, transforms the generated file 205 into graphical illustrations 208. The graphical illustrations 208 include, but are not limited to, textual information of company description and discussion, forward estimates graphics, historical price movement graph, industry tread analysis graph, income and balance sheet data tables, consensus Wall Street opinion chart, ratios and derived data illustrations, and real time updates.

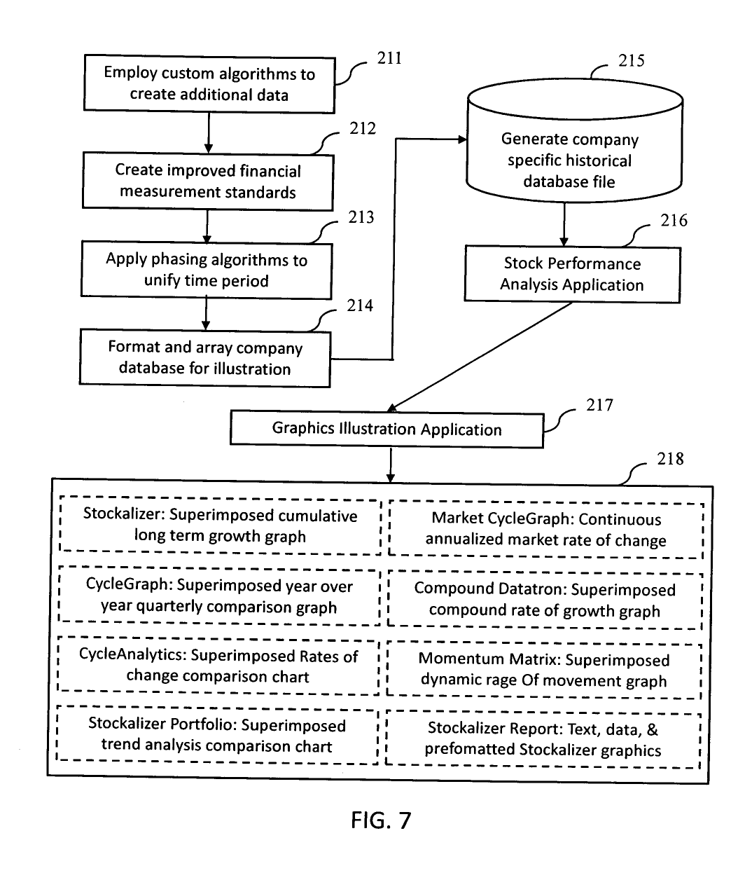

FIG. 7 is a flow diagram illustrating the method for presenting the pattern recognition graphs of stock performance analysis on company specific historical data according to one preferred embodiment of the invention. The method includes the steps of:

Step 211: Employ custom algorithms to create additional data;

Step 212: Create improved financial measurement standards;

Step 213: Apply phasing algorithms to unify time period;

Step 214: Format and array company database for illustration;

Step 215: Generate company specific historical database file;

Step 216: Perform calculations and analysis on stock performance;

Step 217: Transform the results into graphical illustrations.

The graphical illustrations include, but are not limited to, superimposed cumulative long term growth graphs, superimposed year over year quarterly comparison graphs, superimposed rates of change comparison charts, continuous annualized rate of change charts, superimposed compound rate of growth graphs, superimposed continuous dynamic range of movement of stock performance and correlations graphs, superimposed multiple time period snapshot performance graphs, and composite graphical reports.

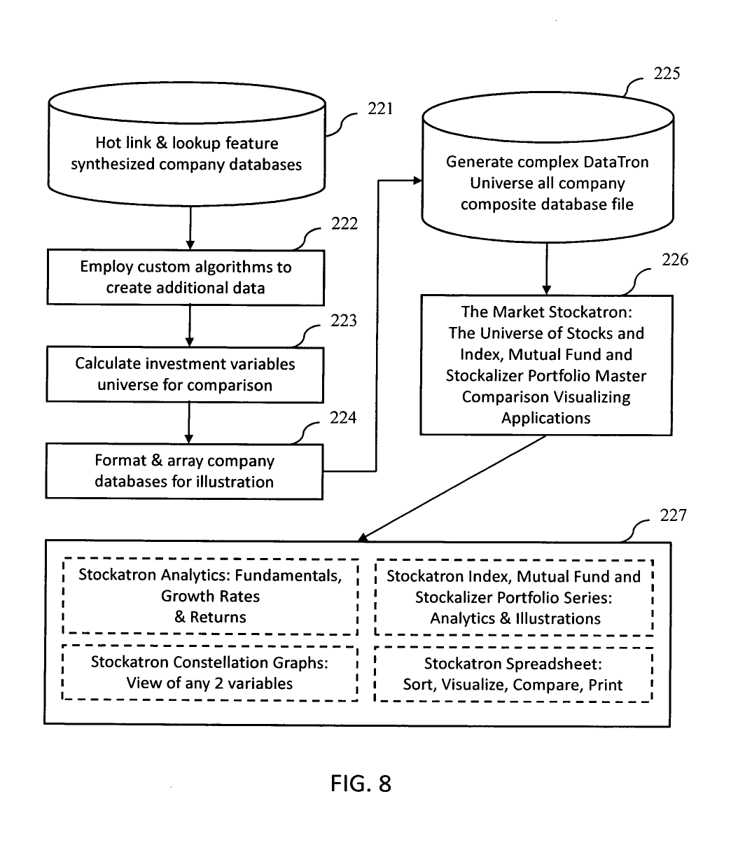

FIG. 8 is a flow diagram illustrating the method for presenting the pattern recognition graphs of stock performance analysis on historical data of all companies according to one preferred embodiment of the invention. The method includes the steps of:

Step 221: Synthesize all company database files;

Step 222: Employ custom algorithms to create additional data;

Step 223: Calculate investment variables universe for comparison;

Step 224: Format and array company databases for illustration;

Step 225: Generate all company composite database file;

Step 226: Perform calculations and analysis on stock performance comparison;

Step 227: Transform the results into graphical illustrations on the comparison.

The graphical illustrations on the comparison include, but are not limited to, (1) fundamentals, analytics, ratios, measures, growth rates and performance returns within a single graph (STOCKATRON Analytics), (2) comparison view of any two variables for a universe of companies (STOCKATRON CONSTELLATION variable comparison graphs), (3) functional buttons or indicators to sort, visualize, compare and print (STOCKATRON UNIVERSE SUMMARY Spreadsheet), and (4) single company textual analytics and illustration (STOCKATRON COMPANY SNAPSHOT, STOCKATRON COMPANY PROFILE).

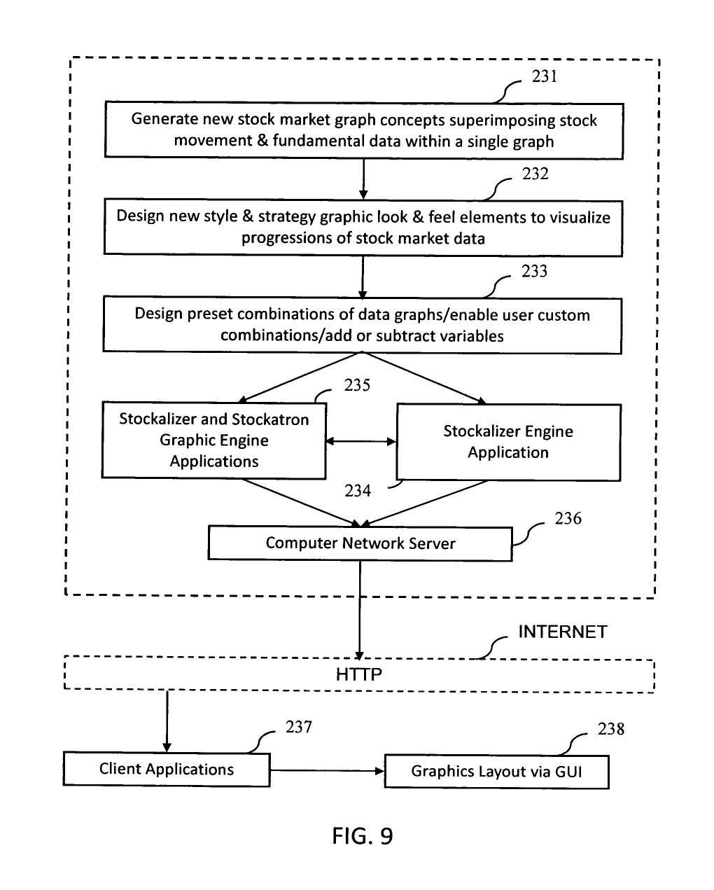

FIG. 9 is a flow diagram illustrating a method for presenting the pattern recognition graphs of stock performance analysis via a computer network such as the Internet according to one preferred embodiment of the invention. The method includes the steps of:

Step 231: Generate new stock market graph concepts superimposing stock movement and fundamental data within in a single graph;

Step 232: Design new style and strategy graphic look and feel elements to visualize progressions of stock market data;

Step 233: Design preset combinations of data graphs;

Step 234: Perform calculations by STOCKALIZER Engine application;

Step 235: Generate graphical illustrations by STOCKALIZER and STOCKATRON Graphic Engine applications;

Step 236: Transfer illustration data files from the server computer to the client computer;

Step 237: Adapt the transferred data files to the client application;

Step 238: Present graphical illustrations via GUI.

There are nine basic pattern recognition graphic styles included in the STOCKALIZER Visualization Charts array of new information package:

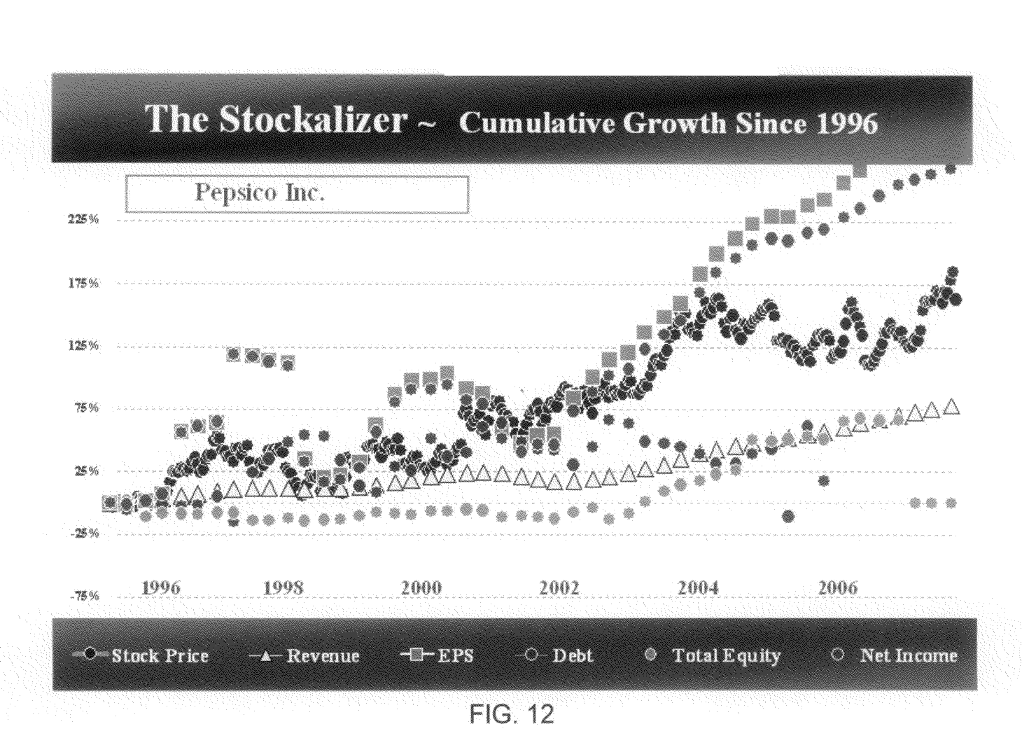

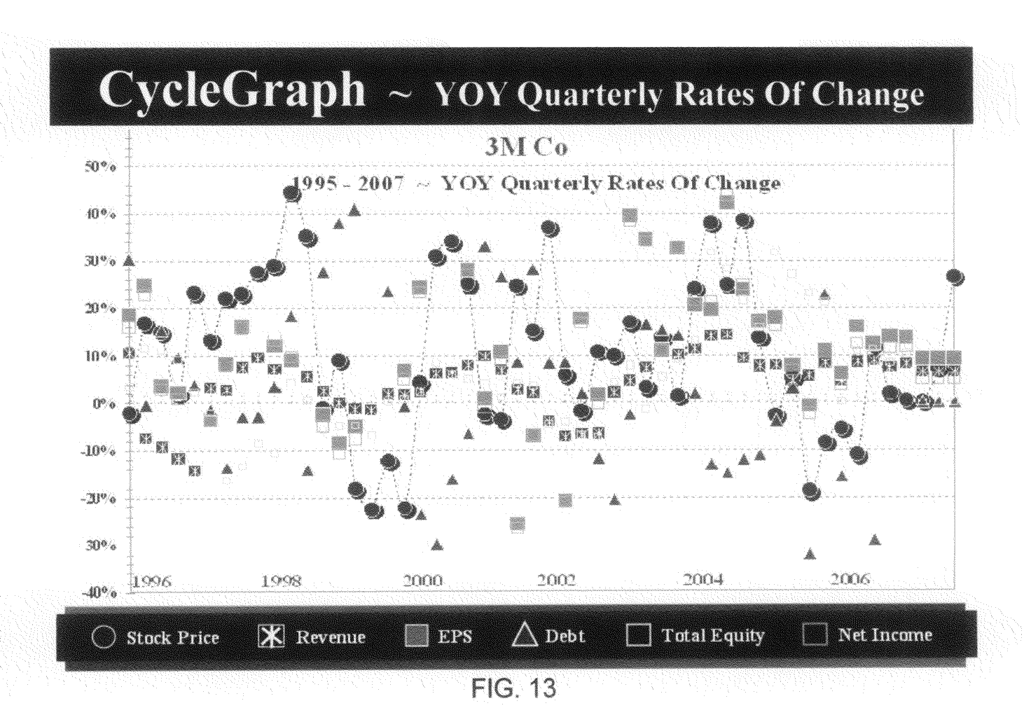

Sample Graph 1. FIG. 12 is a typical graphical presentation of a company's stock performance—cumulative growth from 1995 to 2007. The STOCKALIZER presents a progression of data-point and or a continuous line custom cumulative change horizontal line graph which superimposes combinations of key variables such as stock price movement represented in color circles (such as blue), revenue represented in color triangles (such as yellow), the cumulative change of earnings per share (EPS) represented in color squares (such as green), debt represented in color circles (such as purple), total equity represented in color circles (such as light blue), net income represented in color circles (such as dark green), ERBITDA, and etc. over a single vertical data cumulative % measurement scale, and a horizontal time scale. The user can elect the pre-selected data series, or add or subtract other key variables to view. Sample Graph 2. FIG. 13 is a typical graphical presentation of a company's stock performance—year-over-year quarterly rates of change from 1995 to 2007. The CYCLEGRAPH presents a progression of data-point or a continuous line custom annual rate of change graph which superimposes key year over year quarterly (and more frequently reported time frames) of expression of variables such as stock price movement represented in color circles (such as blue), revenue represented in color marks (such as “*” in a color square), the cumulative change of earnings per share (EPS) represented in color squares (such as blue), debt represented in color triangles (such as purple), total equity represented in color squares (such as yellow), net income represented in color squares (such as red), ERBITDA, and etc. over a single vertical data cumulative % measurement scale, and a horizontal time scale. The user can elect the pre-selected data series, or add or subtract from a wide selection of other key variables to view.

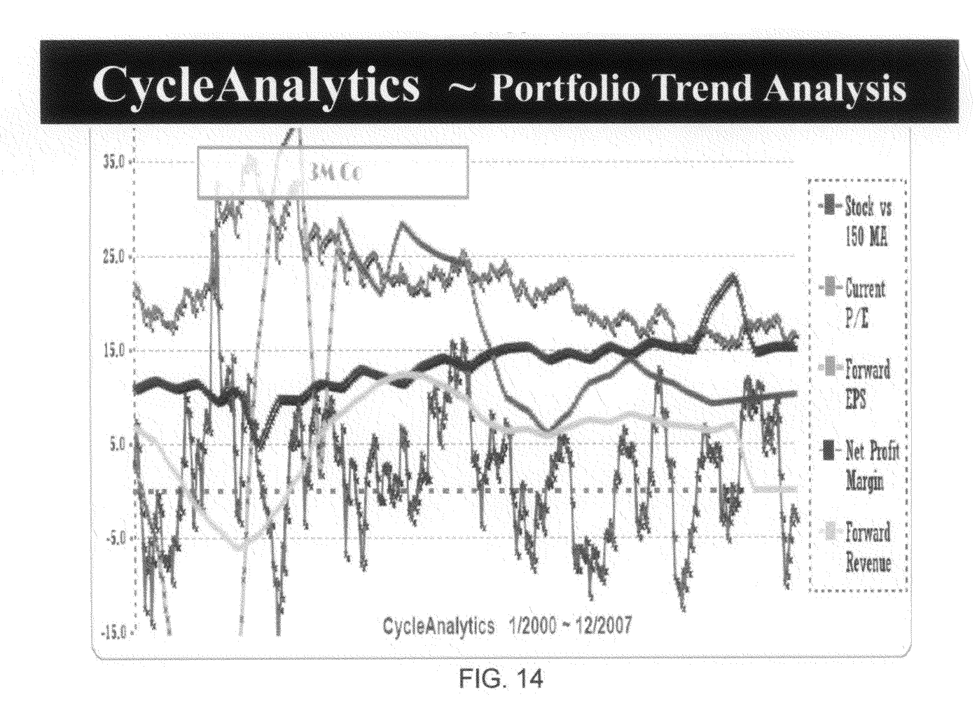

Sample Graph 3. FIG. 14 is a typical graphical presentation of a company's stock performance—evolving tread analysis from 2000-2007. CYCLEANALYTICS presents a continuous line of data-point custom variable period rate of change horizontal line graph which superimposes key year over year quarterly expression (and more frequently reported time frames) of variables which can be stated variously as Trailing, Current or Forward EPS, Revenue, ERBITDA, Profit Margins, Price Earnings Multiple, and Stock Price Movement vs. the 50, 150, annual or variable timeframe. For intuitive viewing, the lines of Stock vs. 150MA, Current P/E, Forward EPS, Net Profit Margin, and forward revenue are color coded. The user can elect the pre-selected data series, or add or subtract from a wide selection of other key variables to view.

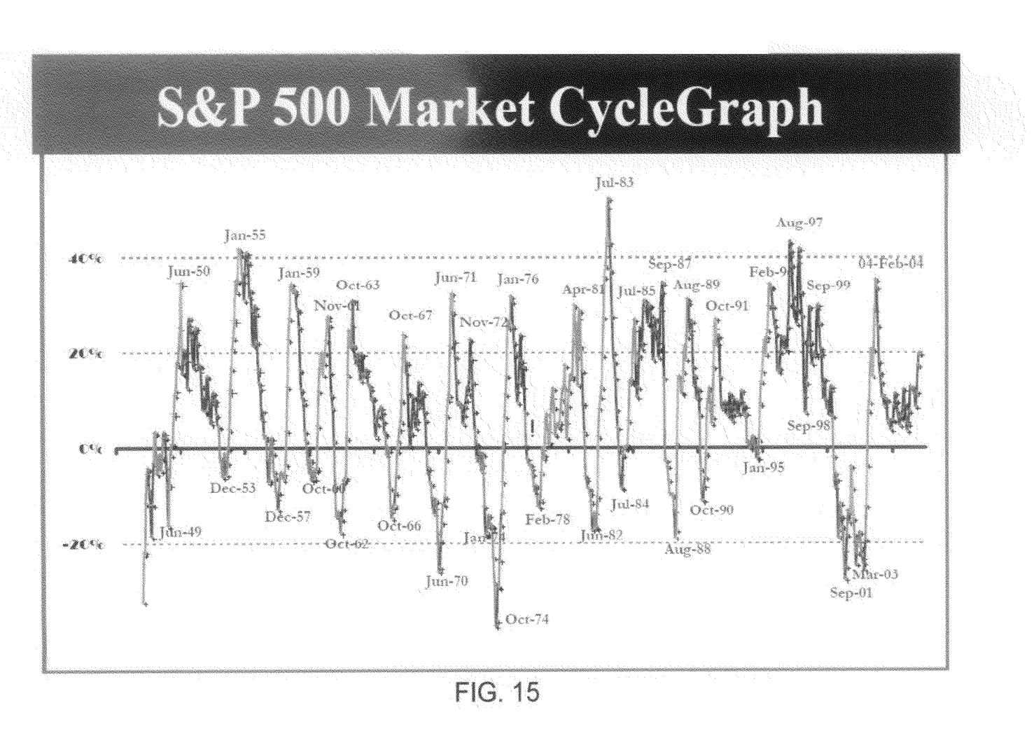

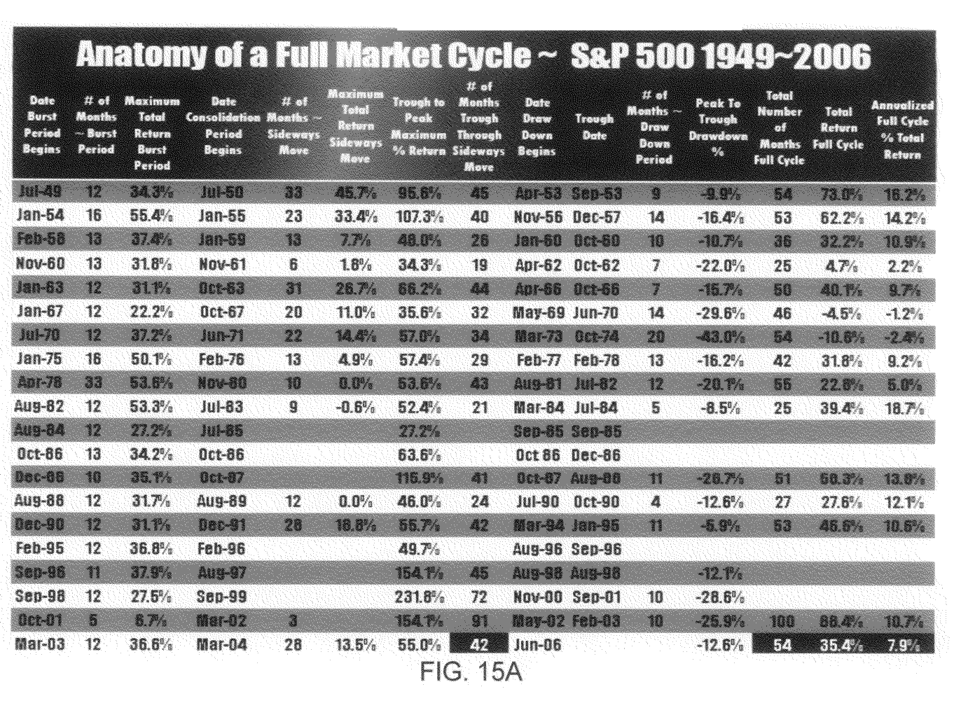

Sample Graph 4. FIG. 15 is a typical graphical presentation of the post world war sixty year 1947-2007 S&P 500 market cycle. The MARKET CYCLEGRAPH presents a custom continuous data-point horizontal line graph which plots index year over year price comparisons of market movement over long time periods. The sample shown is the S&P 500 since 1947, which is color coded to illustrate the three distinct phases of a classically repeating historical full market cycle (Burst Period, Consolidation Phase & Drawdown Periods) which are characteristic of traditional market movement. FIG. 15A is a typical chart presentation illustrating and describing details of the repeating history of full market cycles (Anatomy of a Full Market Cycle).

MARKET CYCLEGRAPHS can be used to illustrate any stock security, length of time, or other measurement duration time periods (vs. 150 moving average etc.).

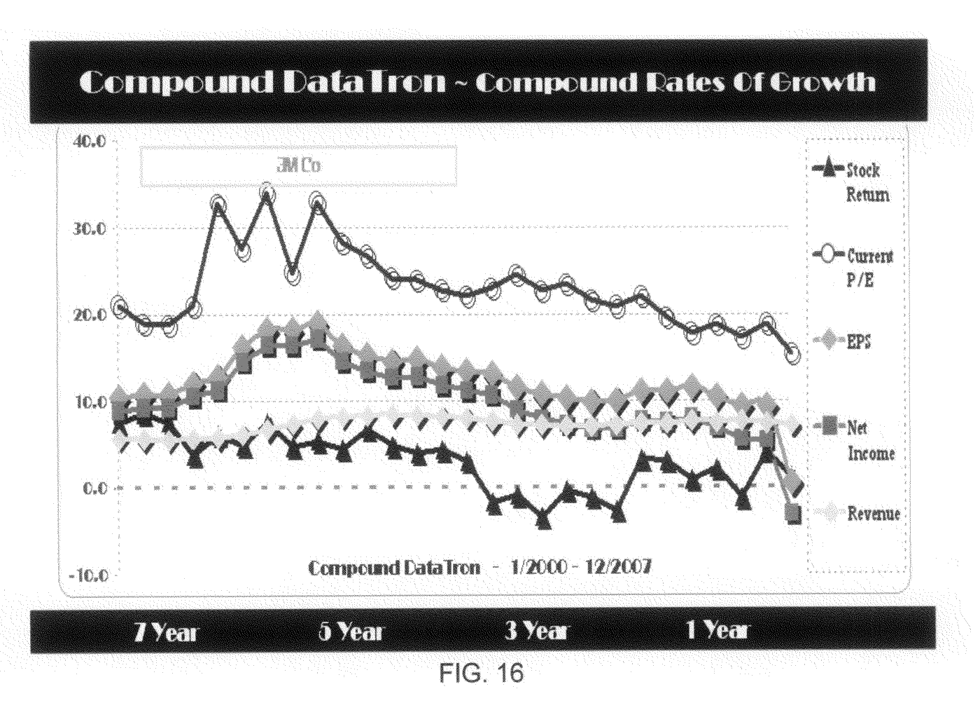

Sample Graph 5. FIG. 16 is a typical graphical presentation of a continuous compound rate of growth graph 2000-2007. The COMPOUND DATATRON presents a continuous data-point custom compounded rate of growth horizontal line graph which superimposes quarter end (and more frequently reported time frames) compounded values of key variables such as EPS, Revenue, ERBITDA, Net Income, Total Equity, Debt, Book Value, ROE, ROA, and Stock Price Movement going back over time. For an intuitive view, distinctive symbols, line textures and are color coding are employed. The user can elect various time periods to illustrate, can view pre-selected data series illustrations, or add or subtract from a wide selection of other key variables to view.

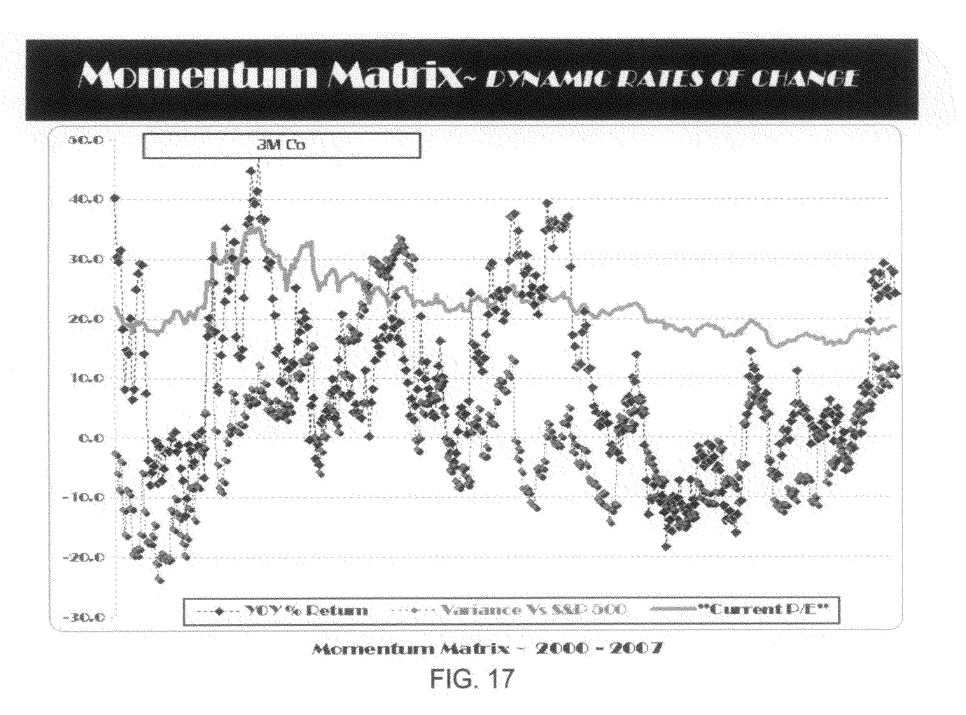

Sample Graph 6. FIG. 17 is a typical graphical presentation for continuous dynamic range of movement. The MOMENTUM MATRIX presents a continuous line of data-point custom dynamic range of movement variable period rate of change horizontal line graph which superimposes the Year over Year; or vs. the 150, 50 day or other time period of Stock Price Movement compared to the Year over Year quarterly and more frequently reported time frames expression of variables which can be stated as Trailing, Current or Forward Fundamentals (combinations of Income, Earnings, Revenue, Profit Margins etc . . . ), Ratios (P/E, ROE, ROA, Beta, Alpha etc . . . ), and +/− Stock Price Performance Variance Comparisons versus major market indexes and other stock price movement volatility measurements. The user can elect the pre-set data series, or add or subtract from a wide selection of other key variables to view.

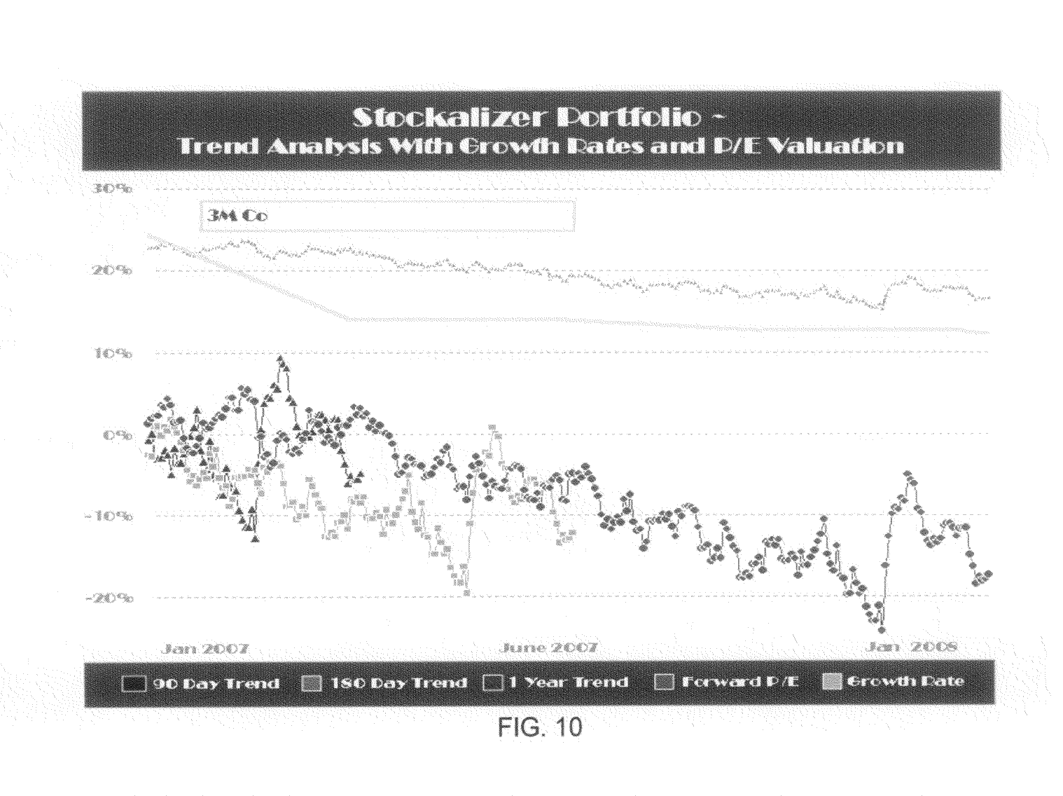

Sample Graph 7. FIG. 10 is a typical graphical presentation of price performance trend analysis. STOCKALIZER PORTFOLIO TREND ANALYSIS price movement charts feature combinations of continuous line data-points presenting multiple time period representations of price performance within the same graph, superimposed with horizontal line graph summary presentations of key short term operating trend measures (EPS, Revenue, Cash Flow, ERBITDA, ROE, ROA, Profit Margins, etc.), and other operating performance or valuation measures such as PE Multiple (Trailing, Current or Forward), operating performance measures such as ROE, ROA, Profit Margins, ETC . . . FIG. 16 in this example, is a typical graphical presentation of a 90, 180 and 365 Day Historical Price Graph Superimposed with Two “Quick Snapshot” variables to provide a short to intermediate term trend analysis of an individual company, industry group or composite portfolio summary. For intuitive view, the lines and data points are color coded. The user can elect various time periods to illustrate, can view pre-selected data series illustrations, or add or subtract from a wide selection of other key variables to view.

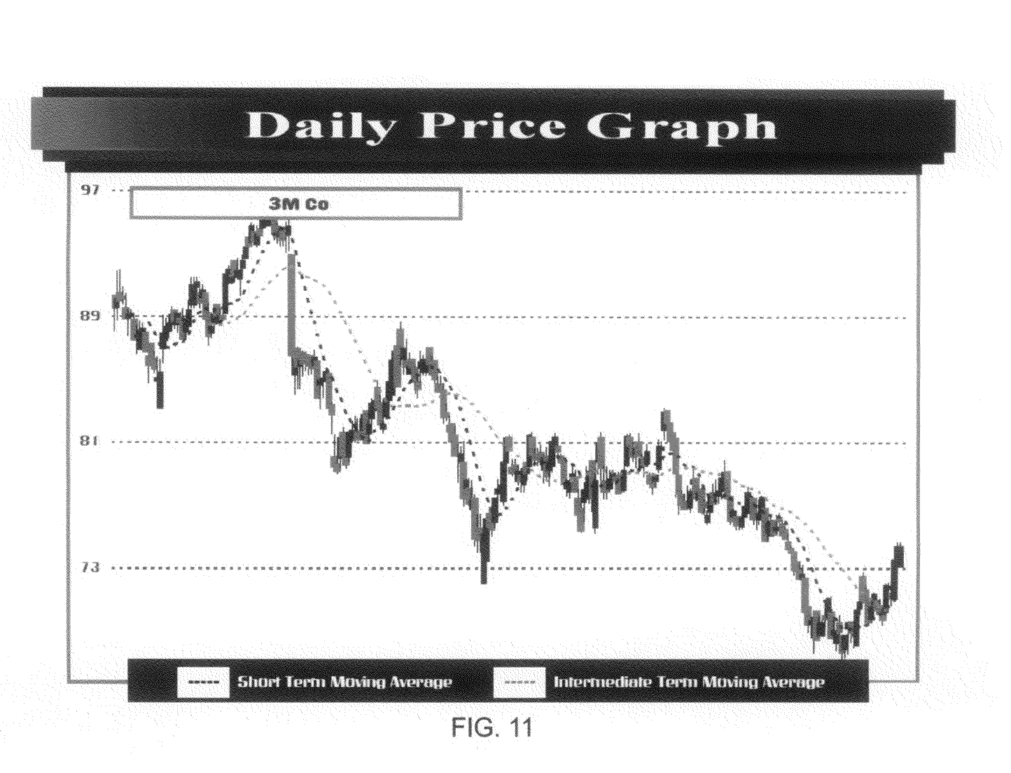

Sample Graph 8. FIG. 11 is a typical graphical presentation of the DAILY PRICE GRAPH Historical price movement chart which presents a custom Open/High/Low/Close color coded “box” horizontal line graph chart which includes color coded short and intermediate term moving averages, and indicates close above or below the open and previous day close information by virtue of specialized color coding combinations.

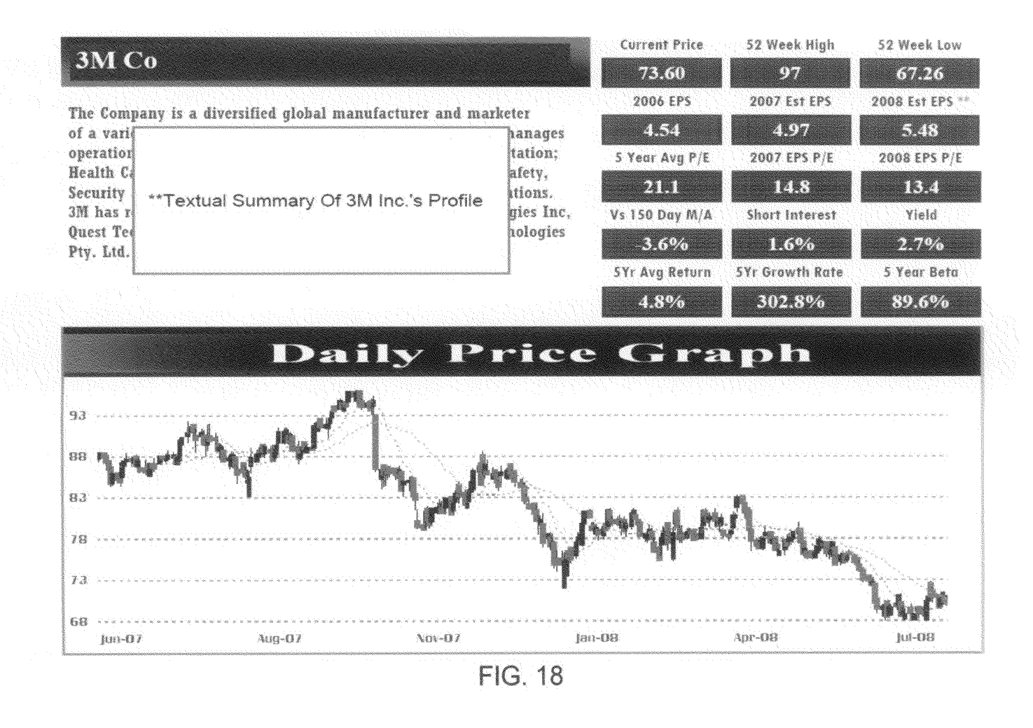

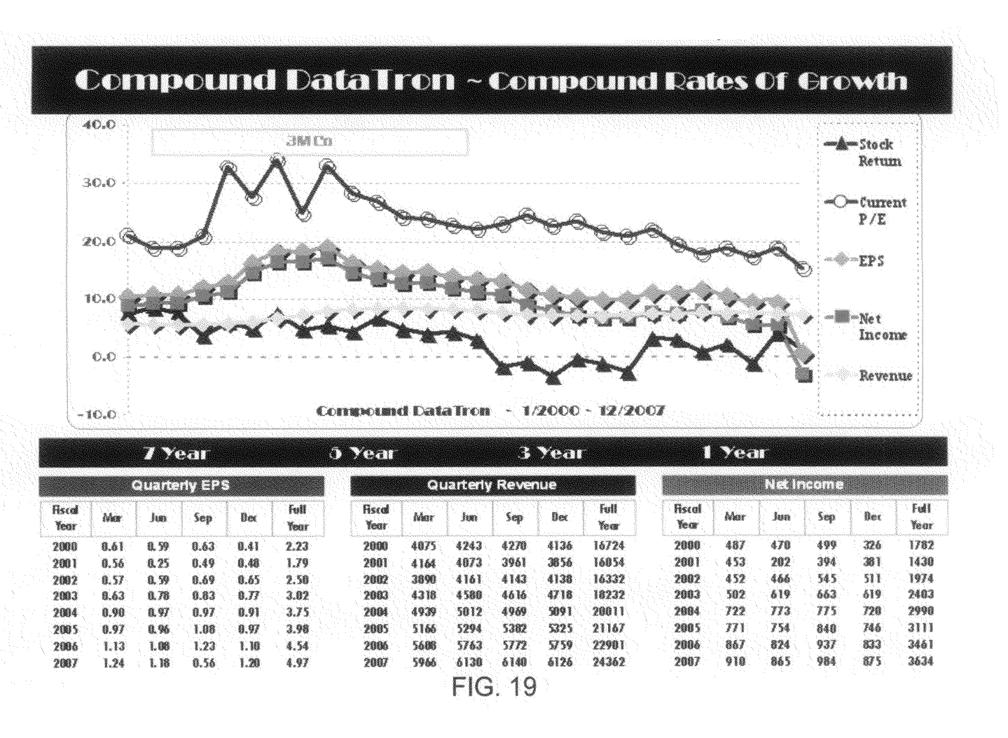

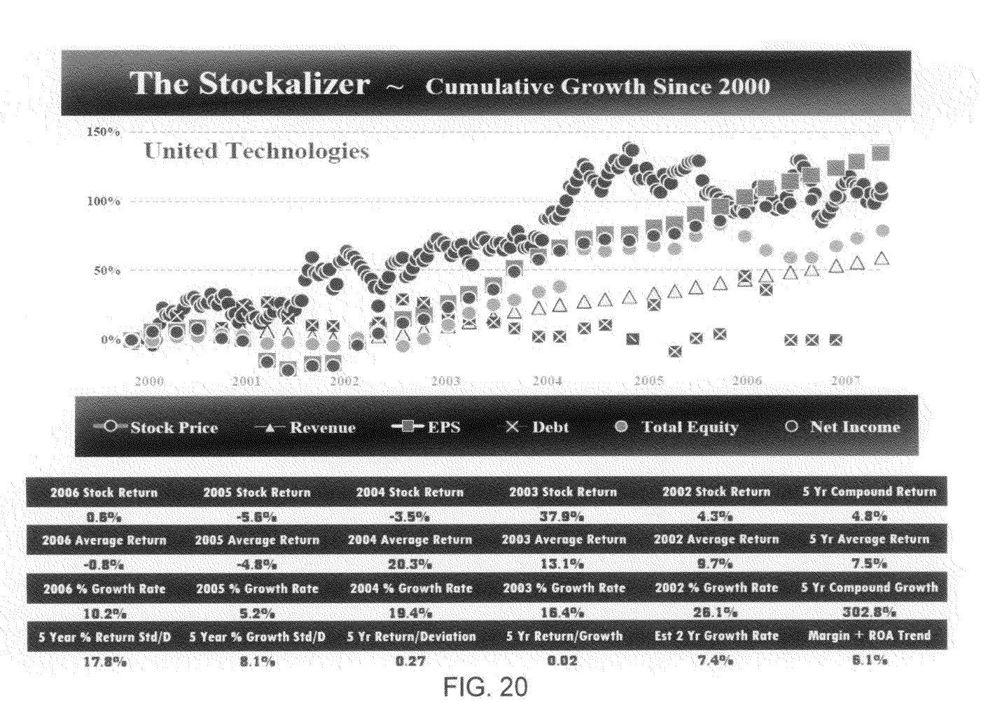

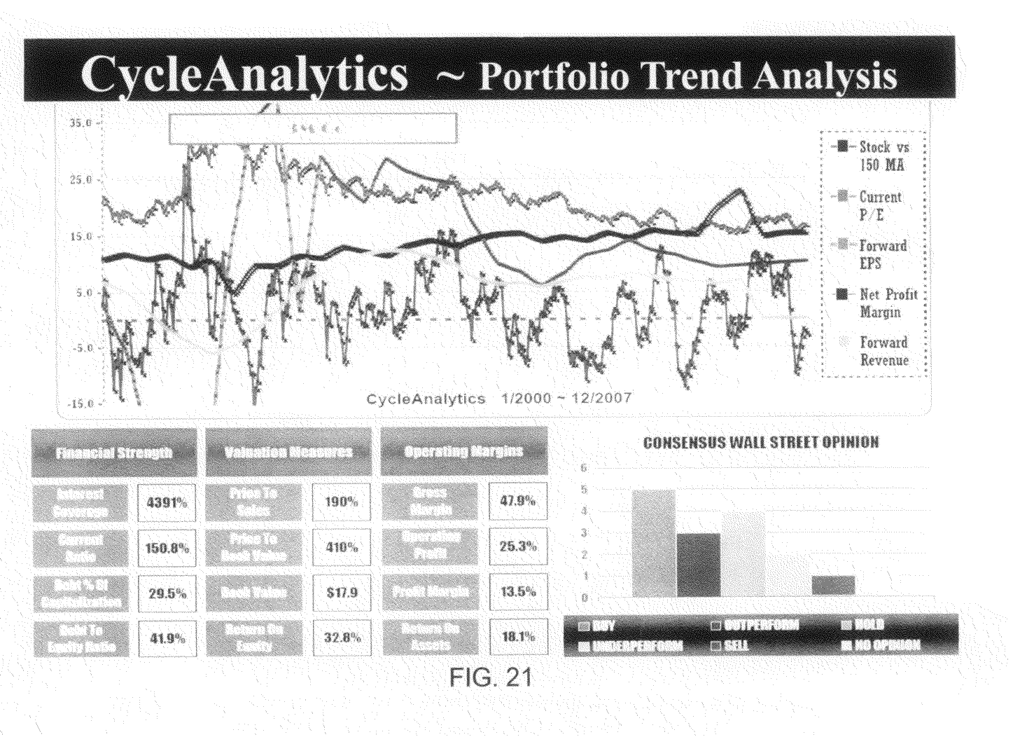

Sample Graphs 9. FIGS. 18-21 illustrate a typical 4-page graphical presentation of a company specific automated composite summary report. The STOCKALIZER REPORT presents a company specific proprietary multiple page composite report containing preformatted elements of text, data tables and proprietary graphs in pre-selected combinations.

The user can visualize and produce an illustrated report on publicly held companies in the United States and most international stocks which trade on primary exchanges around the world with an established track record of published results (about 5000 companies). The United States database includes approximately 3,000 stocks.

The illustrated companies collectively comprise 98% of the combined market value of the publicly traded exchanges in the United States.

However, the usefulness of the tool set is then further enlarged and extends into a series of statistical analysis and portfolio decision making illustration tools which are a natural consequence of the database of information, which is built and updated each time any of the companies contained in the STOCKATRON UNIVERSE of stocks is opened either by the user, or by an automated script that systematically updates the database.

By virtue of having developed a comprehensive database, the user can access the master database of information for viewing, sorting, visualizing and producing a quantity of custom reports and STOCKATRON intellectual property graphic format visualizations.

The system according to the invention can also provide a number of STOCKATRON UNIVERSE visualization charts array of new information package. The user can make use of the database array as he chooses, sorting or selecting data in typical spreadsheet fashion, (i.e. select according to variable, high to low value, by specified value range, etc.) and can view or print the newly sorted data report as they choose. Described below are various sample charts.

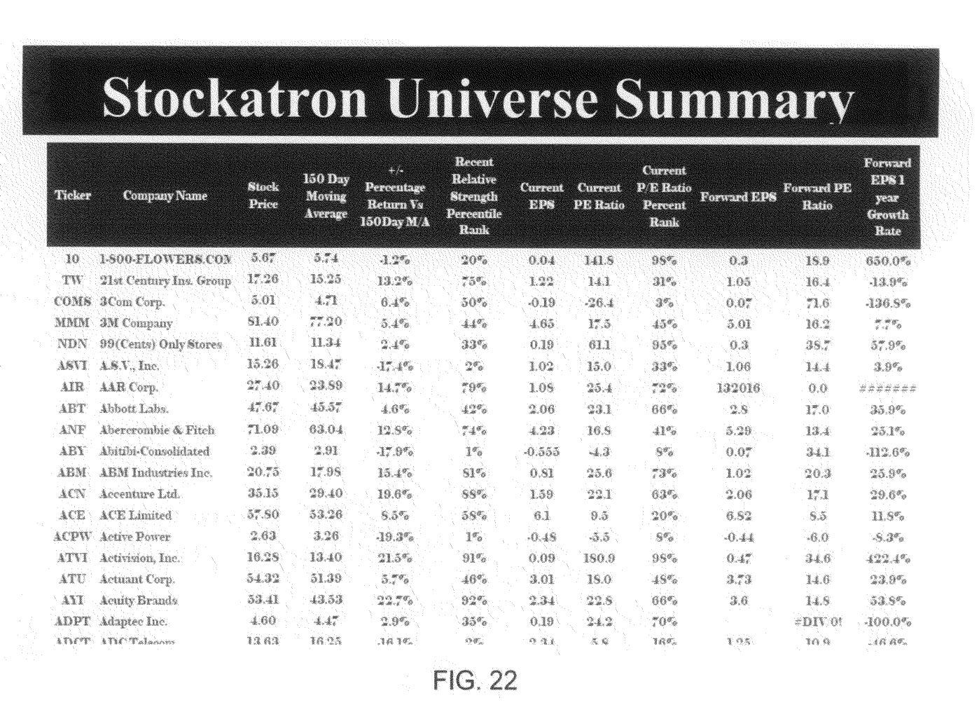

Sample Chart 1. FIG. 22 is a typical graphical presentation of the universe spreadsheet summary. The user can simply type a portfolio of any number of symbols into the template to evaluate and a preformatted STOCKATRON UNIVERSE SUMMARY spreadsheet report is automatically generated via lookup features which itemizes the detail of key operating fundamental variables, technical indicators, ratios, performance characteristics, and other useful information.

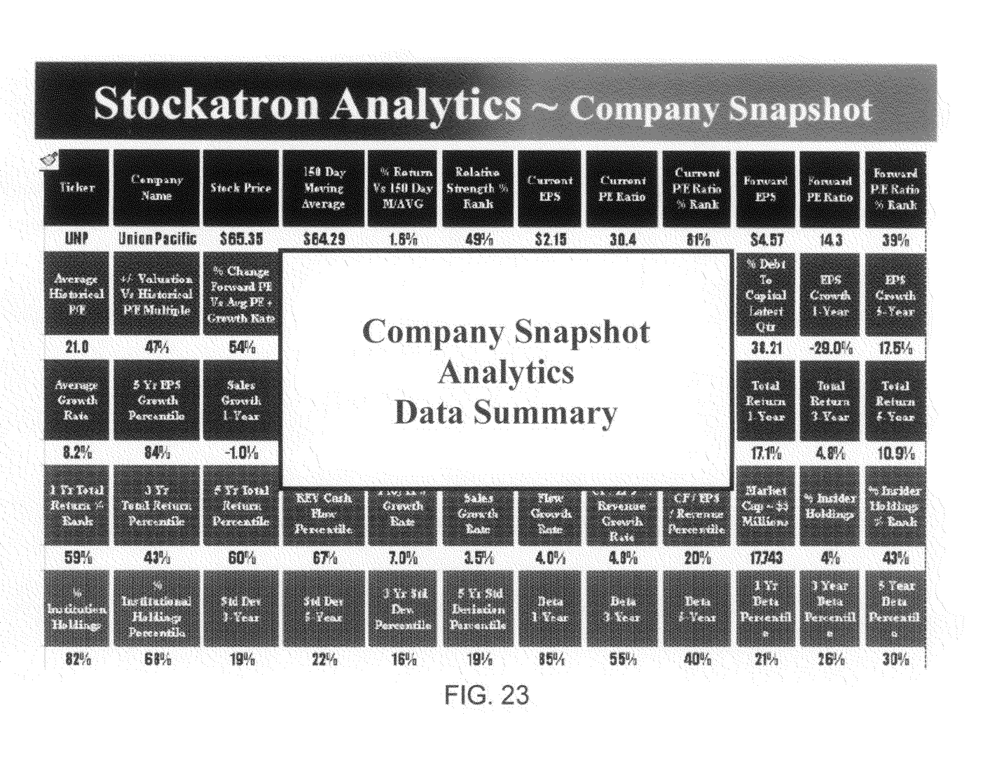

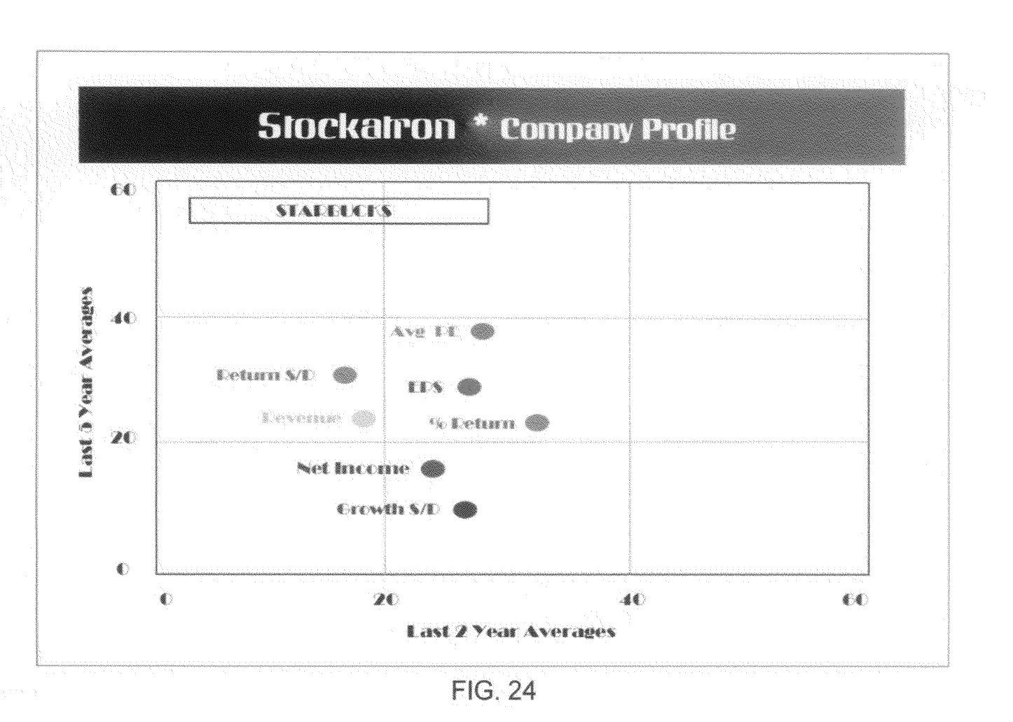

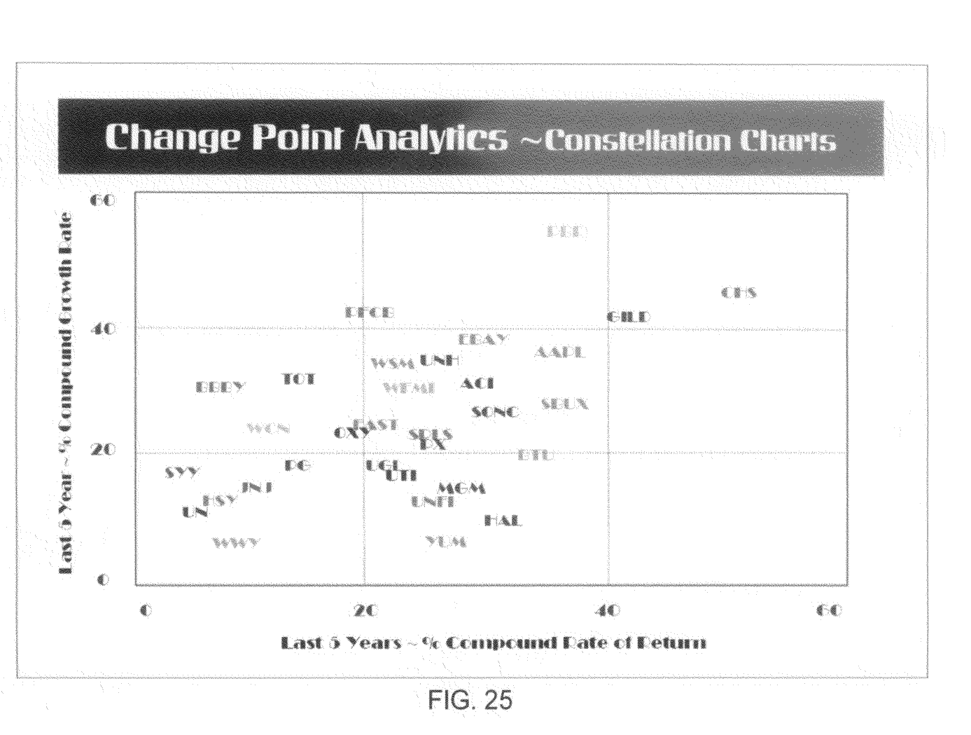

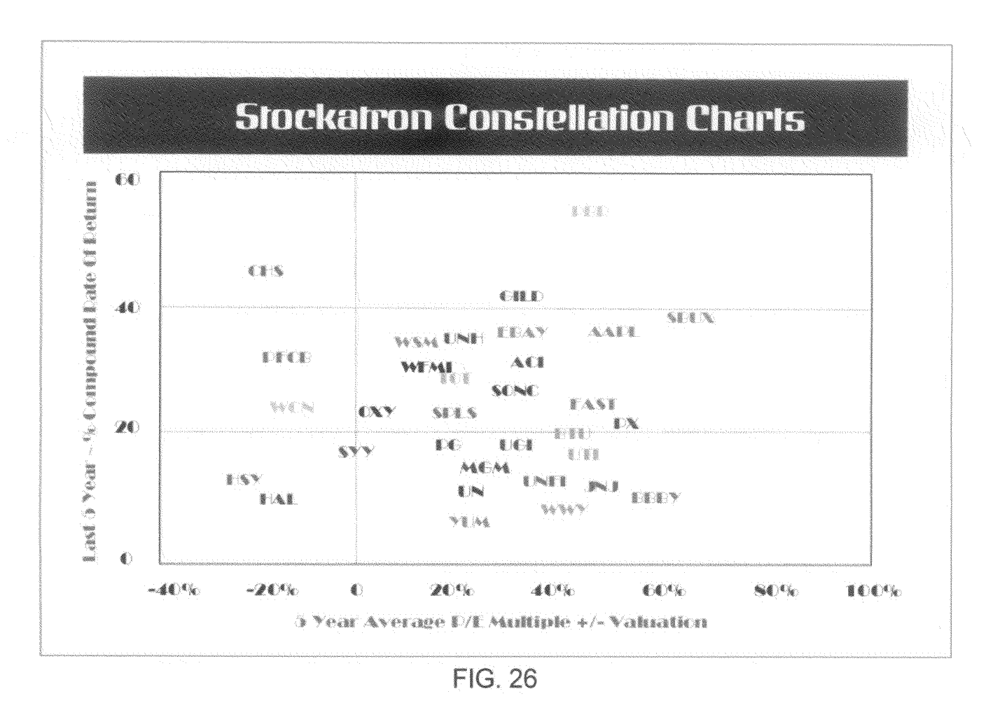

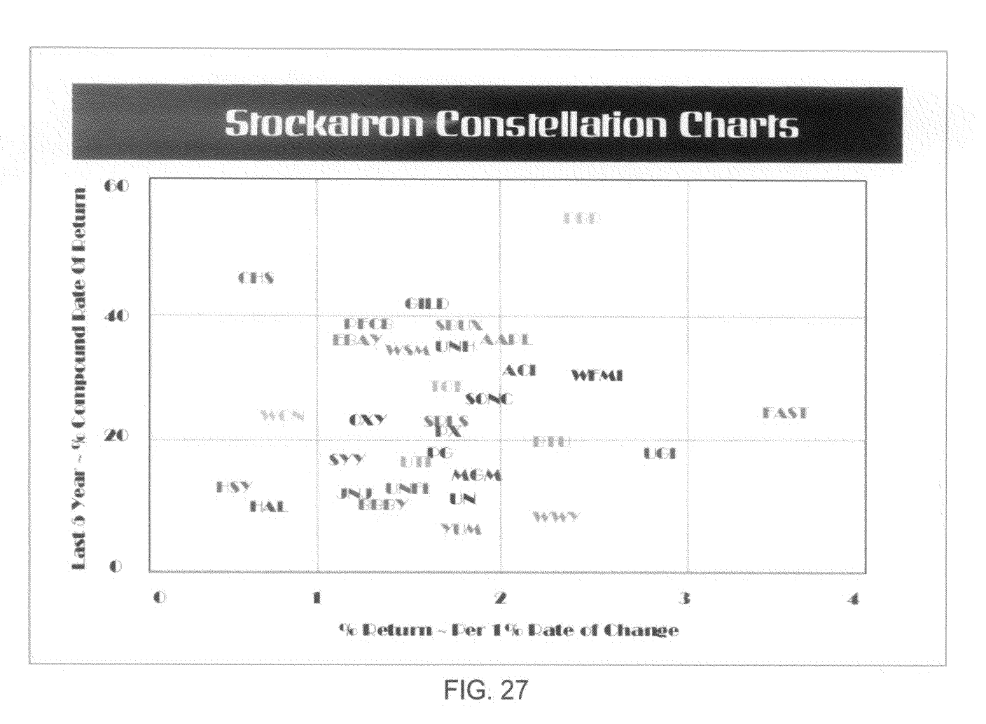

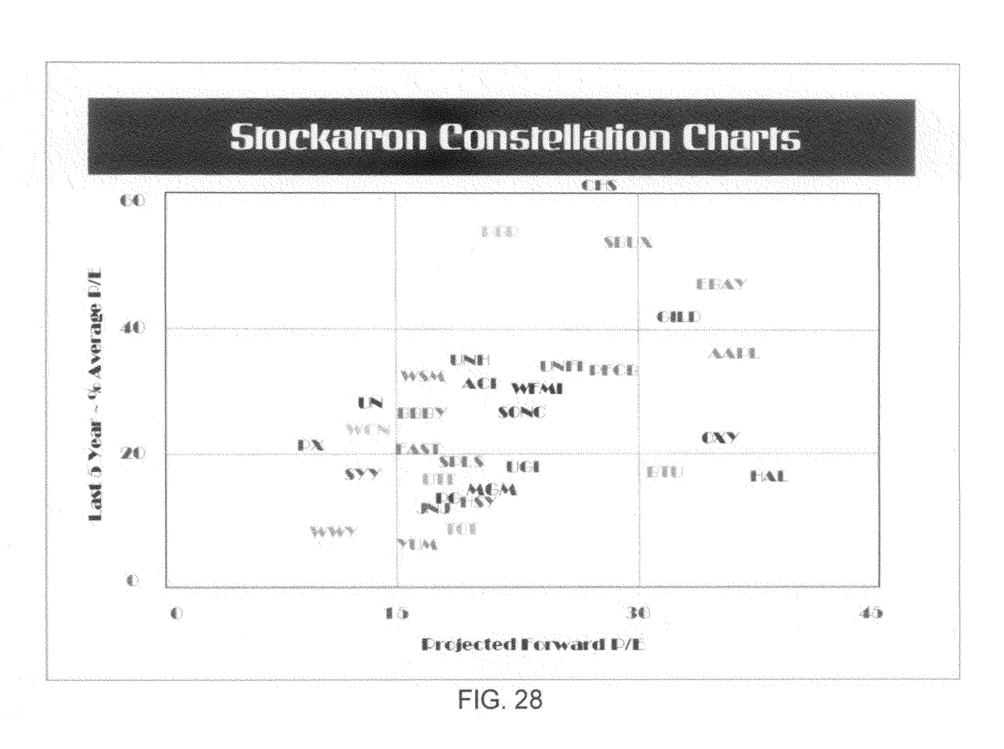

Sample Chart 2. FIG. 23 illustrates a typical graphical presentation for a company specific snapshot summary page. The user can key in a stock symbol and the system will create a STOCKATRON snapshot single page analysis (STOCKATRON ANALYTICS˜COMPANY SNAPSHOT) and accompanying STOCKATRON profile scattergram as shown in FIG. 24 (STOCKATRON COMPANY PROFILE), illustrating key variables in support of a valuation assessment for a single company. In a substantive advancement of the art for financial marketplace graphs, for the first time the user can view or print a series of scattergram STOCKATRON UNIVERSE comparison charts which enable the user to visualize combinations of key variables on two X/Y scales at once in support of a relative value assessment for a single company, or any combination selected of companies contained within the STOCKATRON UNIVERSE of companies database. FIGS. 25-30 illustrate six typical pages of graphical presentation of pre-selected combinations of variables in the database for a universe of companies. The user can choose to view any pre-selected or custom combination of two or more variables in the database for a universe of companies, employing the STOCKATRON UNIVERSE CONSTELLATION graphic comparison chart formats. Formatted charts can either be viewed as graphs only, or graphics can be combined and preformatted along with automated textual boxes wherein individual companies which fit identified profiles are highlighted for preformatted illustration of concept preformatted text discussion.

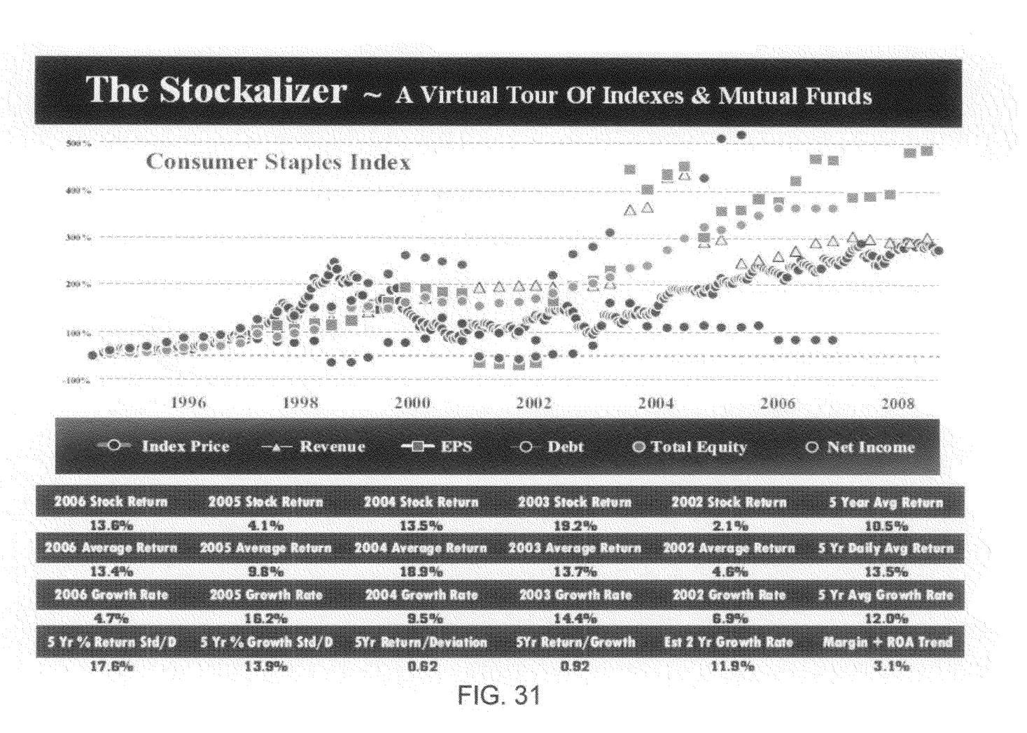

FIG. 25-30, FIG. 31 illustrates a typical graphical presentation of a new innovation data-point indicator using stock symbols, names or variables acronyms in place of dot points. A distinguishing characteristic feature of the STOCKATRON UNIVERSE CONSTELLATION comparison graphics format employed is the use for the first time in a financial comparison graph of the stock symbol (or name or variable criteria), as the data point indicator, which makes it easier to identify and measure the performance of a specific stock in question on two axis scales (measuring two variables at once), and after solving graph and data concentration size and scaling issues, the use of the stock symbols as data points makes it easy to identify and evaluate the relative performance of a large group universe of individual stocks in relationship to each other.

STOCKATRON UNIVERSE and STOCKALIZER individual company database array files are then used as building blocks and combined into a third level database array to form the basis for a new and higher level expression of database management functioning—the STOCKATRON INDEX ANALYZER, THE STOCKATRON MUTUAL FUND ANALYZER AND THE STOCKALIZER PORTFOLIO SERIES of portfolio management tools.

The design function of the STOCKATRON INDEX ANALYZER, THE STOCKATRON MUTUAL FUND ANALYZER AND THE STOCKALIZER PORTFOLIO SERIES of portfolio management tools is to analyze and illustrate synthetic combinations of securities such as an investor's portfolio, indexes, industry groups, mutual funds and professional money manager portfolios employing the STOCKALIZER and STOCKATRON UNIVERSE formats previously described.

The user enters a list of symbols that make up the index or synthetic blend of securities into the STOCKATRON master, and the database array is accessed to form a new file which is a composite array of all of the STOCKALIZER and STOCKATRON information required to form the new synthetic security.

The STOCKATRON master database integration is designed to phase the data via proprietary algorithms and calculate the pro-rata percentage contribution each security plays in the formation of the Index, mutual fund or portfolio being considered. The blended database information is unified to a common scale, and the synthetic security file is saved back into the STOCKALIZER and STOCKATRON UNIVERSE illustration formats for analysis and graphic visualization purposes.

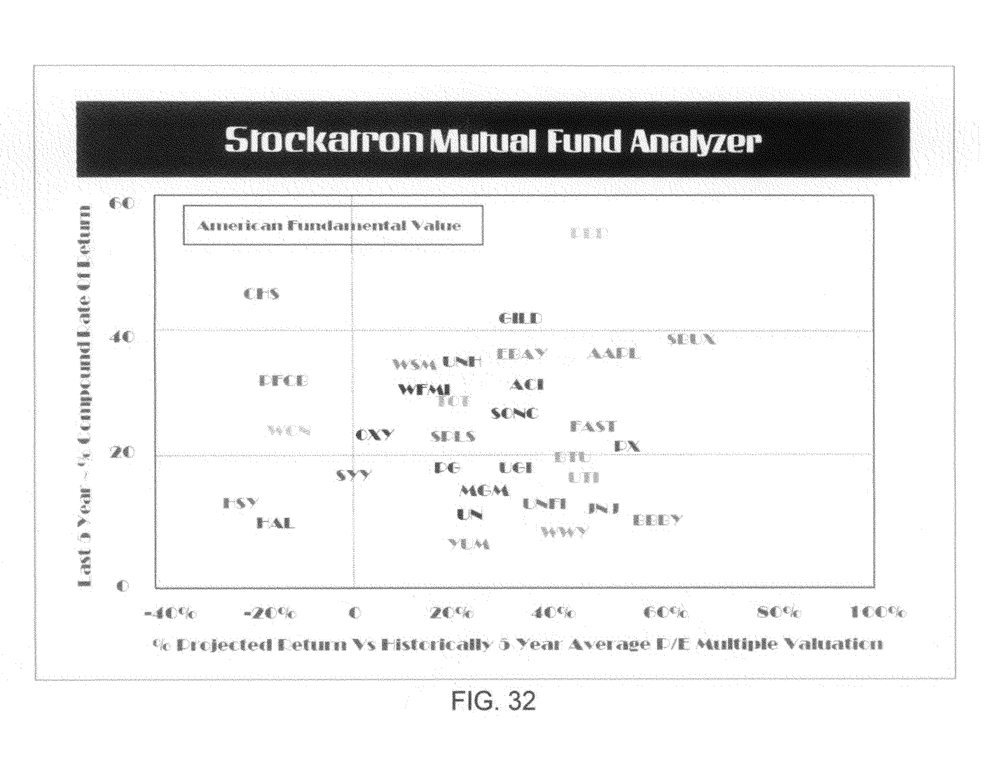

FIG. 32 is a typical graphical presentation which illustrates synthetically combined price performance data for the composite collection of companies contained in indexes, mutual funds and synthetic securities when superimposed over the composite cumulative growth of a variety of operating and balance sheet variables over the same time period; (“The Stockatron Universe˜A Virtual Tour Of Indexes & Mutual Funds”);

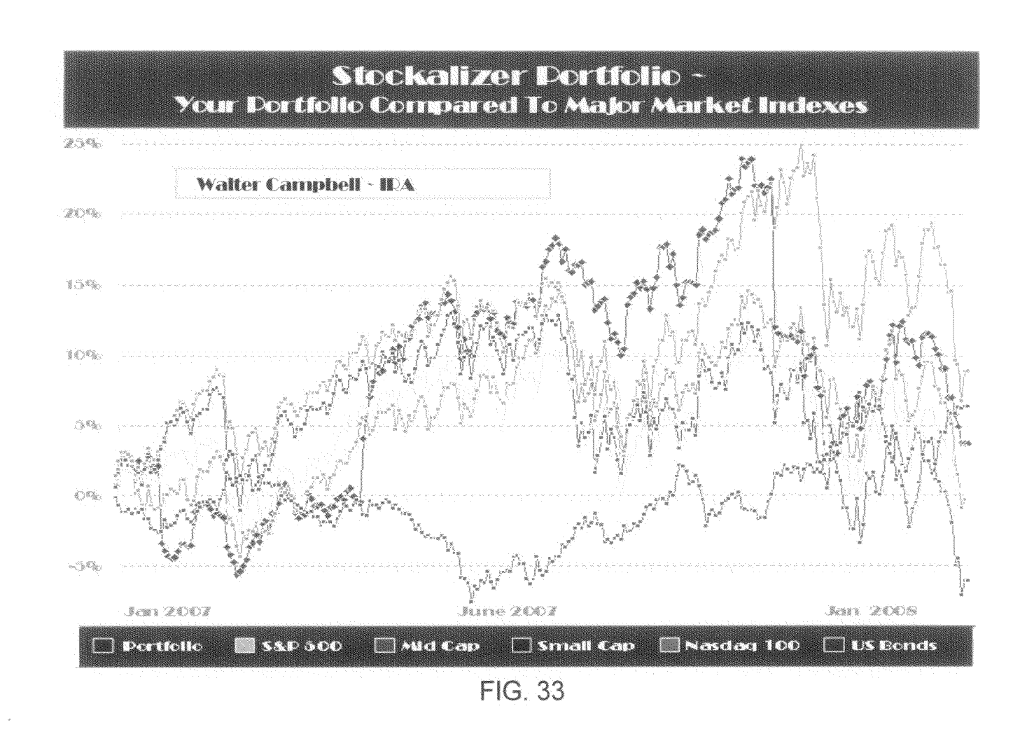

FIG. 33 is a typical graphical presentation of one of the already described “Stockatron Universe Constellation” series of formatted data graphs which are also available to measure and correlate the performance and valuation measures of combinations of mutual funds, indexes or portfolios, or to illustrate the relationship and correlation of the individual component pieces of mutual funds and index components, to be illustrated within the “Stockatron Universe Constellation” comparison chart format series; (“Stockatron Mutual Fund Analyzer”);

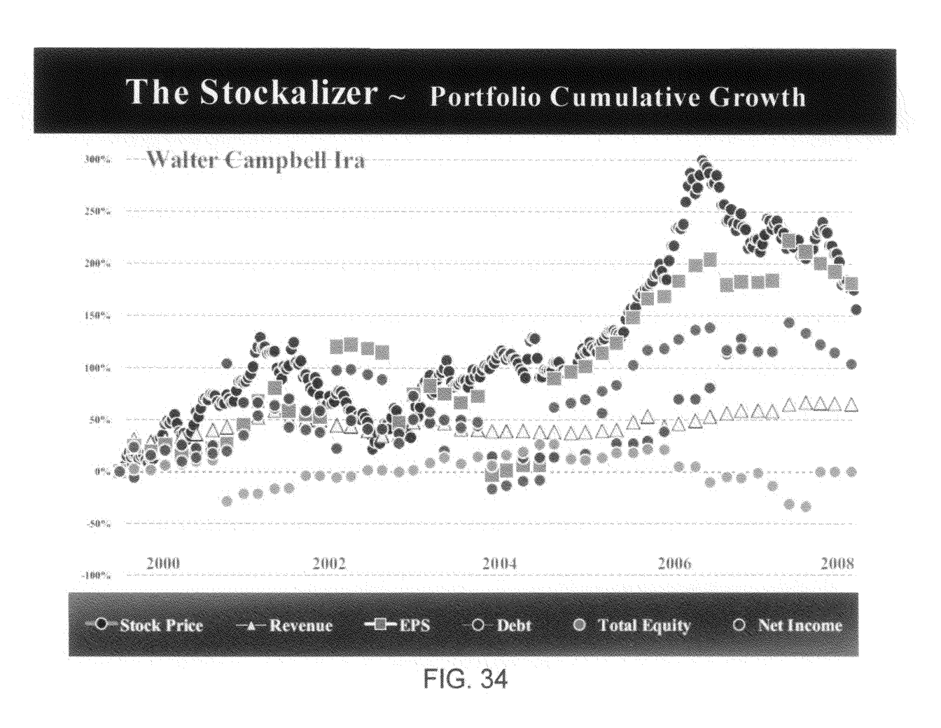

FIG. 34 is a typical graphical presentation of the cumulative composite performance of an investor's portfolio or any synthetic combination of securities, when compared to major market indexes, industry groups, managed accounts, etc . . . as measured on an intraday, daily, weekly, monthly, quarterly, semi-annual, annual, multi year and other variable time period basis; (“Stockalizer Portfolio Comparison to Major Market Indexes”);

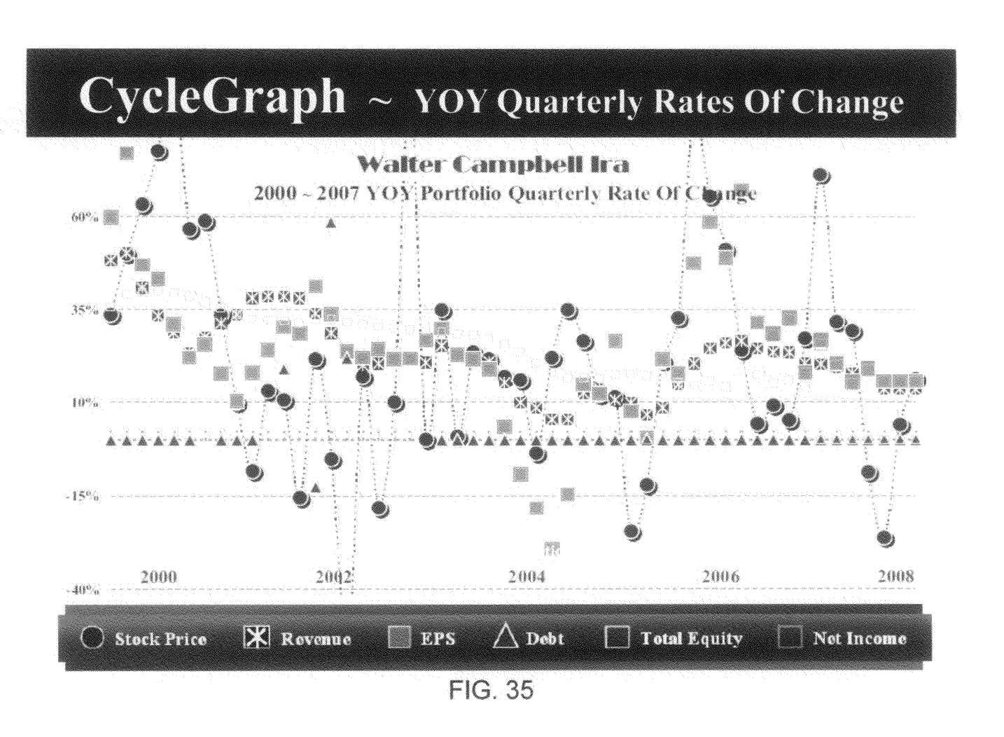

FIG. 35 is a typical graphical presentation of the cumulative growth of stock prices of the pro-rata percentage mix of companies contained within an investor's portfolio when measured over time and superimposed with the cumulative growth of pro-rata operating and balance sheet variables over the same time period; (“The Stockalizer”—Cumulative Growth Rates 2000-2007”);

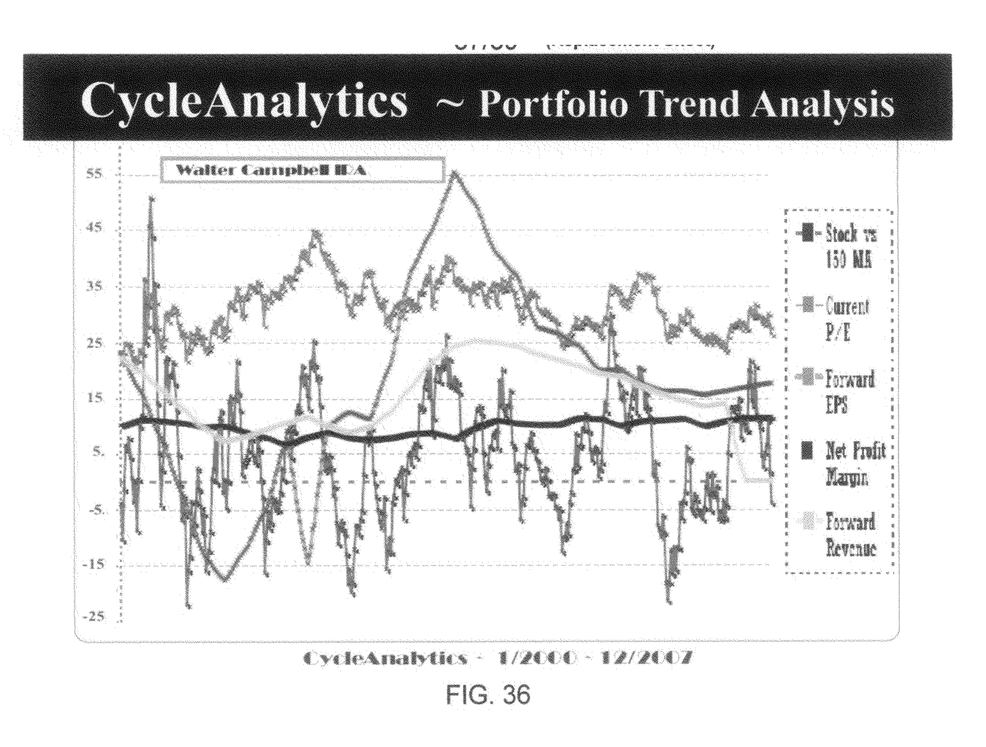

FIG. 36 is a typical graphical presentation of quarterly rates of change for the composite pro-rata percentage mix of companies held in an investor's portfolio when superimposed with a variety of composite operating and balance sheet variables on a Year over Year comparison basis; (“CycleGraph˜YOY Quarterly Rates of Change 1995-2007”);

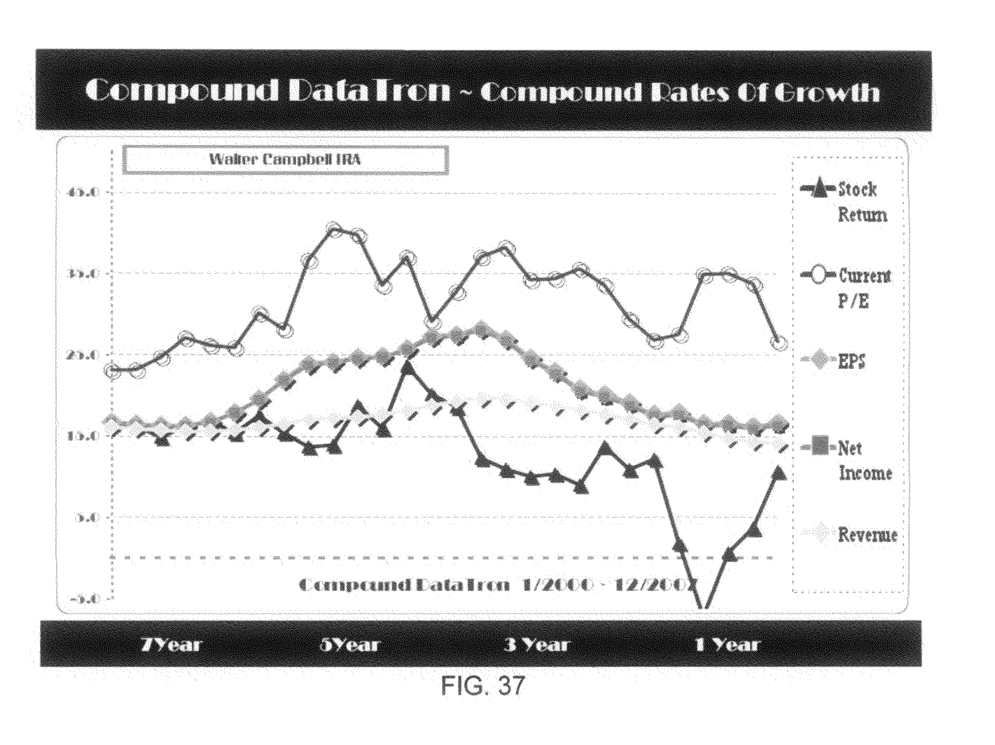

FIG. 37 is a typical graphical presentation of the stock performance of a composite pro-rata percentage mix of companies held in an investor's portfolio when superimposed with a variety of current, trailing and forward looking composite performance, operating and balance sheet variables—evolving trend analysis from 2000-2007; (“CycleAnalytics˜Evolving Trend Analysis”);

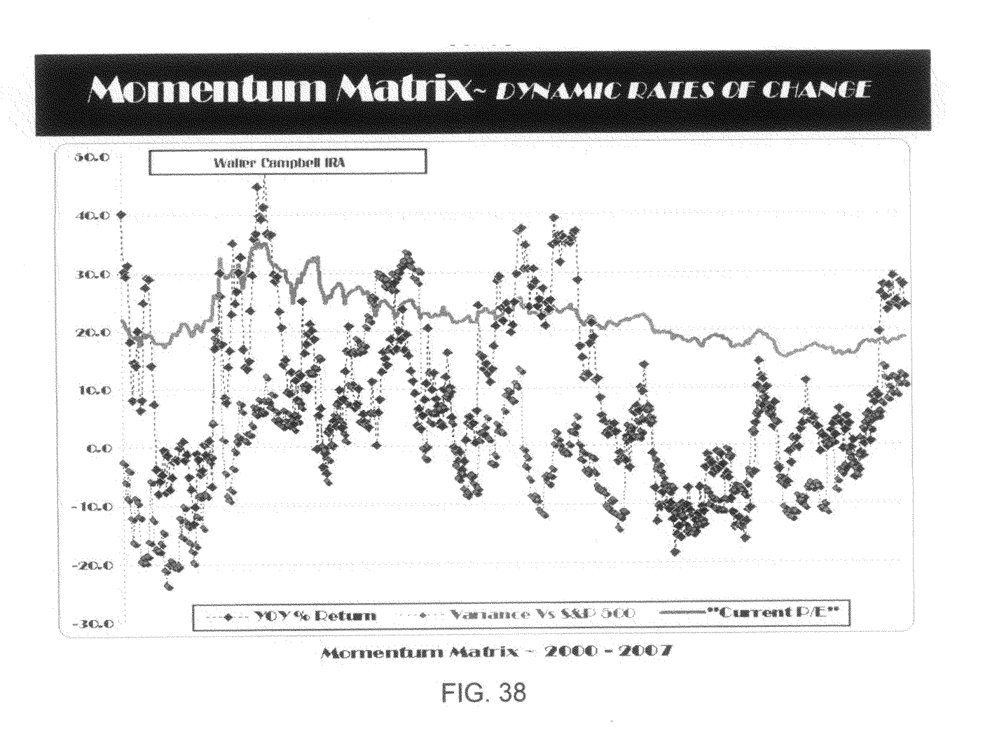

FIG. 38 is a typical graphical presentation of the composite pro-rata percentage mix of companies held in an investor's portfolio when measured for a continuous compound rate of growth comparison of composite price movement, valuation and operating variables—a compound rate of growth graph for 2000-2007; (“Compound DataTron˜Compound Rates of Growth”);

FIG. 39 is a typical graphical presentation of the composite pro-rata percentage mix of companies held in an investor's portfolio, when measured for continuous dynamic range of movement of stock performance, and price movement correlations to industry groups and market indexes, composite valuation measures and operating variables (“Momentum Matrix˜2000-2007”).

Once the new custom blended index composite file is created, the STOCKATRON UNIVERSE synthetic security master file will automatically update and re-calibrate the database and linked STOCKALIZER and STOCKATRON illustrations to reflect ongoing underlying fundamental and price movement changes taking place within the underlying elements in the portfolio.

Commonly employed indexes, industry groups, mutual funds, or any synthetic blend of common stock can be stored in memory to be analyzed and illustrated on demand, in the same manner as any common stock.

Once the new indexes, mutual funds etc. are entered into memory and held as discrete files, a blend of blended securities can also be created. In other words, a user can employ the STOCKATRON UNIVERSE synthetic security master to illustrate any combination of mutual funds, individual stocks, and indexes for portfolio re-balancing, “what if” scenario planning and portfolio selection purposes.

The STOCKATRON UNIVERSE, STOCKATRON MUTUAL FUND ANALYZER, STOCKATRON INDEX ANALYZER, AND THE STOCKALIZER PORTFOLIO management synthetic security data simulation STOCKALIZER and STOCKATRON stock market series graphs, are uniquely new higher level expressions of an unheard of level of far more comprehensive financial data, and represent a historically new genre in documented synthetic stock market graph technology.

These are new function concepts, and there are no other Single Graph˜dual axis horizontal line graph comparison graphs (STOCKALIZER) or Single Graph˜Dual Axis Variable Comparison Scattergram Charts (STOCKATRON) in the market which illustrate the correlation and interrelated progression of market valuation characteristics, stock performance measures, and ongoing change of corporate operating results within a single graph for an individual company, a universe of companies, or a synthetic blend of securities either by design or by function.

Because of perceived, stated and presumed difficulties combining the functions and utility of creating and updating a database of all publicly held companies, deriving and unifying data to a common scale and time period, perceived limitations of usefulness and deficiencies in the potential of current state of the art graphic design formats applicable to illustrating indexes, mutual fund and synthetic securities, current and previous state of the art index and mutual fund stock market comparison graphs are limited to text box descriptions and discussion, style and strategy illustration box charts, price movement graphs of indexes and mutual funds, and simplistic price movement standardized deviation performance comparisons of indexes, mutual funds, and professional money managers.

The present invention includes at least the following inventive features:

1. A stock analyzing application (STOCKALIZER engine) which can create, update and maintain a unique database of separately stored technical and fundamental data for each publicly traded company.

2. Primary database information and further data for each company which is derived is calculated, stored and expressed in daily, weekly, monthly, quarterly and annual incremental periods as required for program functions and operation.

3. Company specific database information is initially composed of publicly available data which is issued directly from the companies themselves in quarterly 10Q and annual 10K SEC mandated filings per universally applied US accounting standards.

4. Initial and updated corporate fundamental database basic file information is manually entered via keyboard entry, or is loaded and automatically updated via linked remote access database connection to information service bureaus.

5. Additional database data is derived, calculated, and stored for each company. The additional derived data is created via commonly available formulas and proprietary algorithms.

6. Estimates and projections, and Consensus Wall Street Opinion information are entered and periodically updated via linked subscription to remote access information service bureaus.

7. The result is the development of a unique new comprehensive database of fundamental balance sheet and income statement information, plus price history, projections, ratios, derived technical and statistical measures, as well as consensus analyst opinions for each stored company.

8. The STOCKALIZER database is arrayed and formatted in such a way as to apply proprietary algorithms to extrapolate additional data required to synchronize variably expressed time periods, such that data can be juxtaposed, manipulated, and viewed within a single scale graph for evaluation and illustration purposes.

9. Database data is available to be juxtaposed and graphed via discreet progressions of dot points, or by continuous line representation via custom algorithms for creating synchronized streams of data˜required as an add-in to allow the STOCKALIZER to operate as a front end to computer generated graphics applications, or via development of a custom graphics package.

10. Graphics employed depend on the use of high contrast color combinations, distinctive graphic symbol lines and shapes, and custom scaling algorithms to depict a close up look at a much larger universe of data within a single graph.

11. The STOCKALIZER engine employs a unique database architectural array concept of arranging data for purposes of calculation, storage, and linking interpolated data cells and files to computer generated custom combinations of formatted text, visualization tables and intuitive high level pattern recognition graphics for network computer terminal screen observation, evaluation, printing and file transfer capabilities.

12. The proprietary illustration formats employed to visualize the database array of financial information represent a new and substantial advancement of the art of displaying financial data and the interrelated progression of ongoing change of published corporate financial results.

13. The custom database array and proprietary new illustration formats solve previously perceived obstacles to allow the viewer for the first time to juxtapose (overlay and superimpose) stock movement and primary and secondary corporate operating fundamentals and performance statistics within the same single scale graph.

14. The STOCKALIZER specific combinations of unique database array, preset automated and custom variable control choices of scaling and phasing of data, and the characteristic qualities of proprietary illustration graphic format design employed, are linked and preformatted to create a new genre of high level pattern recognition stock market graphs. It is specifically the invention of an entirely new genre of data expression˜the STOCKALIZER pattern recognition stock graph, which enables the viewer for the first time to correlate and observe the interrelated progression of stock movement and ongoing change of corporate financial results. Further significance of the invention of new genre STOCKALIZER pattern recognition stock graphs is that pattern recognition is an intuitive tool—a learnable skill which is immediately realized, easily assimilated and logarithmically enlarged over short time periods.

15. The STOCKALIZER new technology provides the ability to juxtapose and combine numbers of combinations of stock market (single stock) fundamental, technical and stock price movement variables in a single graph, using a single measurement scale (vertical), and vs. a second scale for time period (horizontal), as illustrated in the Stockalizer Series Graphs.

This has not been successfully done before in documented single stock evaluation stock market financial market graphs. Because of perceived, stated and presumed difficulties in synchronizing and unifying data to a common scale and time period, combined with perceived limitations and deficiencies in the potential of current state of the art graphic design formats applicable to illustrating stock graphs, current and previous state of the art financial stock market graphs are limited to superimposing text boxes over a graph and arranging or stacking several separate graphs on a single page to assist the viewer with being able to view and consider one or more fundamental variables at a time when comparing fundamentals with stock price movement characteristics over the same time period.

16. Examples of STOCKALIZER breakthroughs in the development of the new genre of illustrating evolving trends of individual companies and market synthetics depend on a combination of interrelated advancements in the art of database program integration development are illustrated and briefly described in FIGS. 6-9. The CHANGE POINT ANALYTICS STOCKALIZER database engine application integration development and the advancements in the art of design of graphic formats which successfully combine fundamental data in stock charts and graphs in new ways are illustrated and briefly described in FIG. 10.

17. Cumulative comparisons of operating variables juxtaposed and combined with numbers of combinations of stock market (single stock) fundamental, technical and stock price movement variables in a single graph, using a single measurement scale (vertical), and vs. a second scale for time period (horizontal). The user can elect the pre-selected combinations of variables, or select their own custom combinations. A line of discrete progression of data-point or a continuous line can be illustrated in the format.

Factors illustrated include: cumulative progressions of stock price movement, earnings per share (EPS), revenue, cash flow, net income, debt, ERBITDA, total equity, and other fundamental, per share or stock price progression measure which can be calculated and compared cumulatively over time. Comparison: there is no other “single˜combined elements” graph like it anywhere in the marketplace, either by design or by function.

18. The year over year quarterly comparisons of operating variables juxtaposed and combined with numbers of combinations of stock market (single stock) fundamental, technical and stock price movement variables in a single graph, using a single measurement scale (vertical), and vs. a second scale for time period (horizontal). Discrete progressions of data point lines or continuous lines can be illustrated in the format as shown in FIG. 11.

Factors illustrated include: cumulative progressions of stock price movement, earnings per share (EPS), revenue, cash flow, net income, debt, ERBITDA, total equity, and other fundamental, per share or stock price progression measure which can be calculated and compared on a year over year quarterly or more frequent reporting period basis over time, or any other element, measure, or ratio that can be calculated on a percentage basis. The user can elect the pre-selected combinations of variables, or select their own custom combinations for illustration.

Comparison: There is no other single stock combined elements graph like it anywhere in the marketplace, either by design or by function. Current and previous state of the art stock market graphs which seek to address the function are limited to superimposing text boxes over a graph and/or rely on arranging or stacking several separate graphs on a single page to assist the viewer with being able to view and consider more than one fundament variable at a time when comparing fundamentals with stock price movement over the same time period.

19. The year over year quarterly and more frequent comparisons of operating variables juxtaposed and combined with numbers of combinations of stock market (single stock) fundamental, technical, valuation and performance ratios, and stock price movement variables in a single graph, using a single measurement scale (vertical), and vs. a second scale for time period (horizontal). A unique feature is that the user may time-shift the expressed data available to be illustrated as any combination of trailing, current or projected data expressions for comparison purposes. Discrete progressions of data-point lines or continuous lines can be illustrated in the format as shown in FIG. 12.

Factors available to be combined in the illustration include: comparison progressions of Year Over Year Stock Price Movement or Stock Movement vs. the Moving Average as measured over various periods, Earnings Per Share (EPS), Revenue or Revenue Per Share, Cash Flow, Net Income, Debt, ERBITDA, Total Equity, Price Earnings Multiple progressions, Profit Margins, and other fundamental, per share or stock price progression measures which can be calculated and compared on a year over year quarterly or more frequent reporting period basis over time, or any other element, measure, or ratio that can be calculated on a percentage basis. The user can elect the pre-selected combinations of variables and phasing of data, or select their own custom combinations

Comparison: This is a new function concept, and there is no other single graph vs. combined elements, time shifted data choices graph like it anywhere in the marketplace, either by design or by function.

To the extent that current and previous state of the art stock market graphs attempt to partially address the functions illustrated in a loosely related way, they are limited to superimposing text boxes over a graph and/or rely on arranging or stacking several separate graphs on a single page to assist the viewer with being able to visualize and consider more than one fundament variable at a time when comparing fundamentals, ratios and measurements with stock price movement over the same time period.

20. The MARKET CYCLEGRAPH year over year % return comparison of performance over long time periods is graphically presented using a single measurement scale (vertical), and vs. a second scale for time period (horizontal).

The MARKET CYCLEGRAPH is a unique chronology of the history of year over year market movement since 1947, and is color coded to clearly indicate the historically usual repeating market cycle, as shown in FIG. 13, which consists of the three sequential and distinct phases of market movement: (1) the initial burst period, (2) the sideways move consolidation phase which follows, and (3) the draw down period of downward movement which concludes the full market cycle.

Market CycleGraph™ can be used to illustrate other variable time periods (since inception, or custom time period), measurement time periods (YOY, vs. the 150 MA, etc.) and can be used to illustrate market cycles in color coded fashion any individual stock, market index, industry group or synthetic collection of stocks, for any length of time desired.

Comparison: This is a new concept and there is no other graph like the MARKET CYCLEGRAPH anywhere in the financial marketplace, either by design or by function.

21. The accompanying study Anatomy of a Full Market Cycle, as shown in FIG. 13a, illustrates the details of the repeating history of full market cycles. There are no published long term cycle analysis studies or graphs of record which depict market cycle dynamics or individual stock cycle analytics in the financial markets.

22. Compound growth rate comparisons of fundamentals, and performance return variables are superimposed with ratios and other indicators within a single graph, using a single measurement scale (vertical), and vs. a second scale for time period (horizontal). Discrete progressions of data-point lines or continuous lines can be illustrated in the format as shown in FIG. 14.

Factors and measurements available to be combined in the illustration include: comparison progressions of stock performance, earnings per share (EPS), revenue or revenue per share, cash flow, net income, debt, ERBITDA, total equity, price earnings multiple progressions, profit margins, and other fundamental, per share or stock price progression measures which can be calculated and compared on compound growth basis over time, or any other element, measure, or ratio that can be calculated on a percentage basis. The user can elect the pre-selected combinations of variables, or select their own custom combinations to illustrate.

Comparison: This is a new function concept, and there is no other “compound growth graph˜superimposed operating and price performance elements” graph like it anywhere in the marketplace, either by design or by function.

23. The “year over year, quarterly, and more frequent comparisons of dynamic range of stock movement” horizontal line graph. Continuous year over year price and variable period rate of change pf price movement can be juxtaposed and combined with continuous price/150 day moving average, calendar year returns, monthly or quarterly open/high/low/close volatility, which are superimposed over key year over year, quarterly and more frequently reported time frames of operating, performance, ratios and valuation variables which can be stated variously as Trailing, Current or Forward measurements.

Variables to be illustrated can include but are not limited to individual expressions of and or combinations of Income, cash flow, ERBITDA, Earnings, Revenue, ROE, ROA, Profit Margins, Stock Price Movement, characteristic expression vs. the 50 and 150 day or other moving averages, annual year over year, year to date and or other variable timeframe price movement, and or daily, weekly, monthly or quarterly Open, High, Low, Close dynamic range of price movement and or other Stock Price Movement Volatility.

Other comparisons include relative performance measurements such as +/− return vs. the S&P500, Nasdaq or other index or performance measure and also the ability to add in additional combinations of single stock fundamental, technical, valuation and performance ratios, and stock price movement variables in a single graph, such as PE, relative Strength, Alpha, Beta, etc., using a single measurement scale (vertical), and vs. a second scale for time period (horizontal).

The user can elect the pre-selected combinations of variables, or select their own custom combinations to illustrate. Discrete progressions of data-point lines or continuous lines can be illustrated in the format as shown in FIG. 15.

Comparison: This is a new function concept, and there is no other “single graph˜combined elements” graph in the marketplace which illustrates dynamic range of movement characteristics compared to combinations of fundamental, technical, valuation and performance ratios, and stock price movement variables in a single graph either by design or by function.

24. The multiple time period stock price movement graphic format chart presents multiple time period short term representations of price performance within the same graph and superimposes variable time period price movement trend analysis with a horizontal line graph presentation summary of growth variables (EPS, Revenue, Cash Flow, ERBITDA etc, blends), and other operating performance or valuation measures such as PE Multiple (Trailing, Current or Forward), operating performance measures such as ROE, ROA, Profit Margins, ETC . . .

Comparison: This is a new function concept, and there is no other “single graph˜multiple time periods combined elements” graph in the marketplace which illustrates the slope line of short to intermediate term stock price movement combined with combinations of short term fundamental, technical, valuation and performance ratios, within a single graph either by design or by function.

24. The stock price movement horizontal box chart˜daily, weekly, monthly price movement graph is expressed as discrete or overlapping progressions of boxes which illustrate open/high/low/close action and which indicates market price close above or below the opening period price by color coding as shown in FIG. 16. The graph also includes color coded pre set or variable moving averages.

25. The viewer can select or deselect custom combinations of data to be illustrated or view the preformatted presets of graphically displayed data.

26. User can select, add or subtract variables by clicking the variable label display.

27. User can change the scaling of graphics to allow for different size and scale looks at the data by clicking on the graph scale.

28. Database progressions are calculated for illustrated data comparison preset time periods, or can be calculated for any variable time period by the user.

29. The size and scope of formatted STOCKALIZER series of graphs displays of data can include Balance Sheet and Income Statements (et al), ratios, financial measures, progressions and measurements of stock movement, technical indicators, etc.

Examples: Earnings per share, earnings˜ongoing operations, ERBITDA, ERBITDA per share, net income, revenue, revenue per share, revenue˜ongoing operations, cash flow, cash flow per share, debt (current, total, segments), profit margins (gross, operating, net, after tax and blends), taxes, depreciation, research and development, business reinvestment, non recurring and discontinued operations, total equity (and subcategories of equity), net capitalization, liquid assets, number of shares, synthesized combinations of variables such as “growth rate”, ratios and measures of financial strength such as book value, return on equity, return on assets, debt to capitalization, debt to equity, and stock performance measures and ratios such as price to earnings ratio (PE˜trailing, current or forward), price to sales ratio (trailing, current or forward), price to book value, price to business reinvestment, and derive data such as dividend yield, price vs. moving averages, relative strength, performance percentile, average calendar returns, average daily returns, average growth rates, stock performance as a % of growth rate, standardized deviation of stock performance, standardized deviation of growth rates and growth rate components, alpha, beta, Z factor, +/− performance variance for stock performance or operating performance when compared to major market indexes or industry groups and other relevant factors.

30. Complex specific STOCKALIZER database files for each company contain cells which are linked to an automatically updating “all company” master database, the STOCKATRON UNIVERSE of stocks file. Besides being linked to each discrete individual company database file, the STOCKATRON UNIVERSE database is programmed to synthesize additional derived data to form the basis of a series of sorting, analytics, and custom graphic display and reporting output functions. The STOCKATRON UNIVERSE application generates, updates, and maintains a unique database of separately stored technical and fundamental data for each publicly traded company. Primary database information and further data for each company which is derived is calculated, stored and expressed in daily, weekly, monthly, quarterly and annual incremental periods as required for program functions and operation. Additional database data is derived, calculated, and stored for each company. The additional derived data is created via commonly available formulas and proprietary algorithms. The result is the development of an additional unique new comprehensive database of fundamental balance sheet and income statement information, plus price history, projections, ratios, derived technical and statistical measures, and consensus analyst opinions for each stored company.

31. The STOCKATRON UNIVERSE database is arrayed and formatted in such a way as to apply proprietary algorithms to extrapolate additional data required to synchronize variably expressed time periods, such that data can be unified, juxtaposed, manipulated, and viewed within an automatically optimized common scale graph for evaluation and illustration purposes.

32. STOCKATRON and STOCKALIZER Graphics employed depend on the intelligent grouping of a large array of previously unexpressed yet crucial data relational price value progression relationships, innovative scaling of related variables to consider, the use of high contrast color combinations and distinctive proprietary advancements in graphic labeling, and the successful pioneering of an innovative series of new genre stock market specific graphic formats to clearly depict a much larger universe of data within a single graph which successfully conveys high level fundamental analysis information easily to any user without the requirement of any specialized training.

33. The STOCKATRON UNIVERSE employs a unique database architectural array concept of arranging data for purposes of calculation, storage, and linking interpolated data cells and-files to computer generated custom combinations of formatted text; visualization tables and intuitive high level pattern recognition graphics for network computer terminal screen observation, evaluation, printing and file transfer capabilities.

34. The viewer can select or deselect custom combinations of data to be illustrated or view the preformatted presets of graphically displayed data.

35. User can change the scaling of graphics to allow for different size and scale looks at the data by clicking on the graph scale.

36. Company specific STOCKATRON UNIVERSE analytics are available to the user. The user inputs a stock symbol, and up pops a display suitable for printing which itemizes a preformatted visualization single page summary of operating and performance characteristics for evaluation purposes as shown in FIG. 22.

37. The size and scope of formatted displays of STOCKATRON data can include Income Statement (et al), ratios, financial measures progressions and measurements of stock movement, technical indicators, etc.

Examples: earnings per share, earnings˜ongoing operations, ERBITDA, ERBITDA per share, net income, revenue, revenue per share, revenue˜ongoing operations, cash flow, cash flow per share, debt (current, total, segments), profit margins (gross, operating, net, after tax and blends), taxes, depreciation, research & development, business reinvestment, non recurring and discontinued operations, total equity (and subcategories of equity), net capitalization, liquid assets, number of shares, synthesized combinations of variables such as “growth rate”, ratios and measures of financial strength such as book value, return on equity, return on assets, debt to capitalization, debt to equity, and stock performance measures and ratios such as price to earnings ratio (PE˜trailing, current or forward), price to sales ratio (trailing, current or forward), price to book value, price to business reinvestment, and derive data such as dividend yield, price vs. moving averages, relative strength, performance percentile, average calendar returns, average daily returns, average growth rates, stock performance as a % of growth rate, standardized deviation of stock performance, standardized deviation of growth rates and growth rate components, alpha, beta, Z factor, +/− performance variance for stock performance or operating performance when compared to major market indexes or industry groups and other relevant factors.

38. Sorting and analyzing the STOCKATRON UNIVERSE is easy. The user opens the master file, and views, sorts, and analyzes the database of information. The user can view the volume of rows and columns the “all company” master file of accumulated data in alphabetical order or sorted by variable fashion, or can type in a series of stock symbols to consider and can view an abbreviated summary page of pre-selected variables in typical spread sheet fashion as shown in FIG. 22.

39. The proprietary illustration formats employed to visualize the database array of financial information represent a new and substantial advancement of the art of displaying financial data and the interrelated progression of ongoing change of published corporate financial results.

40. Company specific STOCKATRON profile charts are available to the user. The user inputs a stock symbol, and an innovatively new breakthrough technology financial graphic format design “scattergram” chart, as shown in FIG. 24 depicting combinations of key operating and performance characteristics of any selected stock in the database is available for evaluation and printing purposes.

The proprietary new STOCKATRON COMPANY PROFILE chart format (FIG. 24) is a custom X-Y financial measurement comparison chart which is designed to measure a large number of key operating and performance characteristics variables on two measurement scales at once.

A substantial number of operating and performance measurement qualities, as well as combinations of axis measurements are available to be graphed in the “single company stock profile variable comparison chart” format. Examples given: combinations of % return, EPS, Revenue, Return Standardized Deviation, Growth Rate Standardized Deviation, Net Income, Return By Time Period, historically usual P/E Multiple etc. Variables can be expressed as trailing, current and forward measurements.

Labeled measurements in the graphic can include variable combinations such as: % stock performance; annual, average or compounded return expressed for time periods; standardized deviation characteristics; statistical variance vs. major market indexes or industry groups; projected vs. historically usual PE valuation; % operating growth rate; single measurements or synthesized combinations of EPS, REV, cash flow, net income, ERBITDA, profit margins, etc; ratios such as ROA, ROE, PE˜current, trailing, forward, historically usual; statistical measures such as change as % of Z factor, alpha, beta, etc.

41. The entire synthesized database of the STOCKATRON UNIVERSE is also available to visualize a proprietary series of relative valuation/performance characteristics STOCKATRON CONSTELLATION comparison charts. The user can view numerous combinations of relative value, stock performance, operating performance and technical stock analysis. The user simply inputs a series stock symbol, and the graphics engine generates a display graph which is illustrated in a custom X-Y scattergram format, suitable for printing which itemizes a preformatted visualization summary of operating and performance characteristics for evaluation purposes.

The user simply inputs as many company symbols into the template as they desire to evaluate on a measurement and comparison basis, and a series of preformatted relative value, stock performance, operating performance and technical stock analysis STOCKATRON CONSTELLATION Comparison Charts are available to the user for stock selection, analysis and portfolio management purposes.

42. The proprietary new format is a custom X-Y scattergram financial measurement comparison chart which is designed to measure and compare any two key operating and performance qualities of a large universe of companies, on two measurement scales˜in a single illustration as shown in FIGS. 25-30.

Axis measurements include variable combinations such as: % stock performance (calendar return over time periods, standardized deviation, average return over time periods, projected vs. historically usual PE valuation ), % operating growth rate (synthesized combinations of EPS, REV, cash flow, net income, ERBITDA etc), ratios (ROA, ROE, PE˜current, trailing, forward, historically usual), statistical measures (change as % of Z factor, alpha, beta,)

Comparison with existing patented technology˜STOCKATRON stock profile variable comparison and STOCKATRON CONSTELLATION comparison stock market graphs, are uniquely new higher level expressions of far more comprehensive financial data, and represent a historically new genre in documented stock market graph technology.

These are new function concepts, and there are no other “single graph˜dual axis comparison graphs” in the marketplace which illustrate the correlation and interrelated progression of market valuation characteristics, stock performance measurements, and ongoing change of corporate operating results for an individual company or a large combination of user selected companies contained in the universe of companies, either by design or by function.

Because of perceived, stated and presumed difficulties combining the functions and utility of creating and updating a database of all publicly held companies, deriving and unifying data to a common scale and time period, perceived limitations of usefulness and deficiencies in the potential of current state of the art graphic design formats applicable to illustrating X-Y “scattergram” stock graphs, current and previous state of the art financial stock market comparison graphs are limited to superimposing text boxes over a graph and arranging or stacking several separate graphs on a single page to assist the viewer with being able to view and consider more than one or more fundamental variables at a time when comparing fundamentals, ratios, measures and stock performance characteristics over the same time period.

43. STOCKATRON UNIVERSE and STOCKALIZER individual company database array files are then used as building blocks and combined into a third level database array to form the basis for a new and higher level expression of database management functioning˜the STOCKATRON INDEX AND MUTUAL FUND ANALYZER, and the STOCKALIZER PORTFOLIO series of tools.

44. The STOCKATRON INDEX AND MUTUAL FUND ANALYZER, and the STOCKALIZER PORTFOLIO series of tools design function is to analyze and illustrate synthetic combinations of securities such as investor portfolios, indexes, industry groups, mutual funds and professional money manager portfolios employing the entire series of STOCKALIZER and STOCKATRON UNIVERSE formats already described.

45. The user enters a list of symbols that make up the index or synthetic blend of securities into the STOCKATRON INDEX, MUTUAL FUND, or the STOCKALIZER PORTFOLIO master template, and the database array is accessed to form a new file which is a composite array of all of the STOCKALIZER and STOCKATRON UNIVERSE information required to form the new synthetic security.

46. The STOCKATRON INDEX, MUTUAL FUND and STOCKALIZER PORTFOLIO database integration is designed to phase the data via proprietary algorithms and calculate the pro-rata percentage contribution each security plays in the formation of the new synthetic security.

47. The newly created STOCKATRON INDEX AND MUTUAL FUND ANALYZER master blended index and mutual fund analysis database, and the STOCKALIZER PORTFOLIO analysis database information is unified to a common scale, and a synthetic security file is saved back into the STOCKALIZER and STOCKATRON UNIVERSE series formats for analysis and illustration purposes, a selection of samples of which are shown in FIGS. 32-39, but which also include any of the demonstrations of data and illustration formats previously described in FIGS. 10-30.

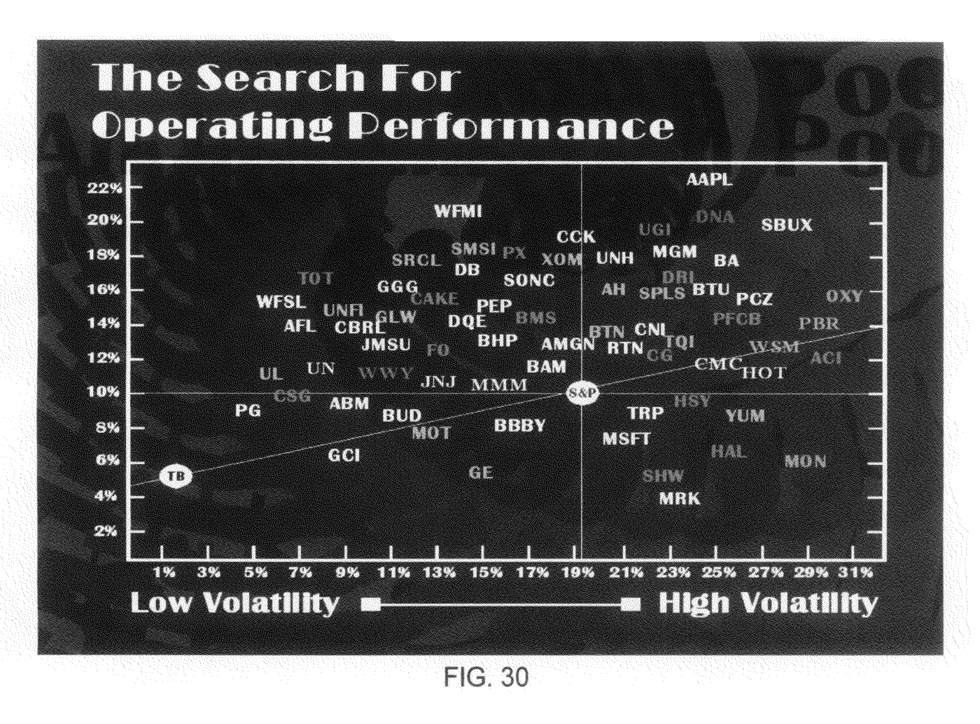

48. Another new distinctive new innovation feature of the STOCKATRON stock profile variable comparison chart and STOCKATRON UNIVERSE comparison charts graphic format advancement of the art, is the automated first time use of a performance or operating variable name, acronym or stock symbol as the data point label indicator within a financial stock graph as shown in FIG. 25-29, and FIG. 30.

49. The STOCKATRON UNIVERSE comparison charts illustrated progressions can be calculated and illustrate data comparisons for present 1-2-3-4-5-7-10 year periods, or can be calculated for variable periods as selected by the user.

50. The STOCKATRON stock profile variable comparison charts and STOCKATRON UNIVERSE comparison charts depend on the creation of a new database array of information; the development of a new higher level of a comprehensively complete database universe of publicly traded companies; invention of new proprietary derived data measurements; refinements in the protocol of existing industry standard measurements; and the successful new invention of proprietary new illustration formats; all of which advance the art of meaningful graphic presentation within financial graphs; to solve previously perceived obstacles to allow the viewer for purposes of evaluation, display and printing for the first time to juxtapose (overlay and superimpose) stock movement, ratios, primary and secondary corporate operating fundamentals and performance comparison statistics within the same X-Y style “scattergram” double scale graphic format design, as shown in FIGS. 23-29.

51. The STOCKATRON UNIVERSE specific combinations of unique database array, custom variable control choices of scaling and phasing of data, and the characteristic qualities of proprietary illustration graphic format design employed, are linked and preformatted to create a new genre of high level STOCKATRON stock profile variable comparison and STOCKATRON UNIVERSE comparison stock market graphs.

52. It is specifically the combination of the invention of an entirely new genre of data expression˜the creation of STOCKATRON stock profile variable comparison and STOCKATRON universe comparison stock market graphs, when combined with a more comprehensive database development technology, which enables the viewer for the first time to correlate and observe in a new way, the interrelated progression of market valuation characteristics, stock performance measurements, and ongoing change of corporate operating results.

53. Further significance of the invention of a new genre decision making and portfolio management STOCKATRON stock profile variable comparison and STOCKATRON UNIVERSE comparison stock market graph tool set, is that the use of the STOCKATRON stock profile variable comparison and STOCKATRON UNIVERSE comparison graphing program is an intuitive tool˜a learnable skill which offers high speed pattern recognition, easy assimilation and logarithmically enlarged observation skills over short time periods.

54. Once the new custom blended index file is created, the STOCKATRON INDEX AND MUTUAL INDEX ANALYZER master file will automatically update and re-calibrate the database and linked STOCKALIZER and STOCKATRON series illustrations to reflect ongoing underlying fundamental and price movement changes taking place within the underlying elements in the portfolio.

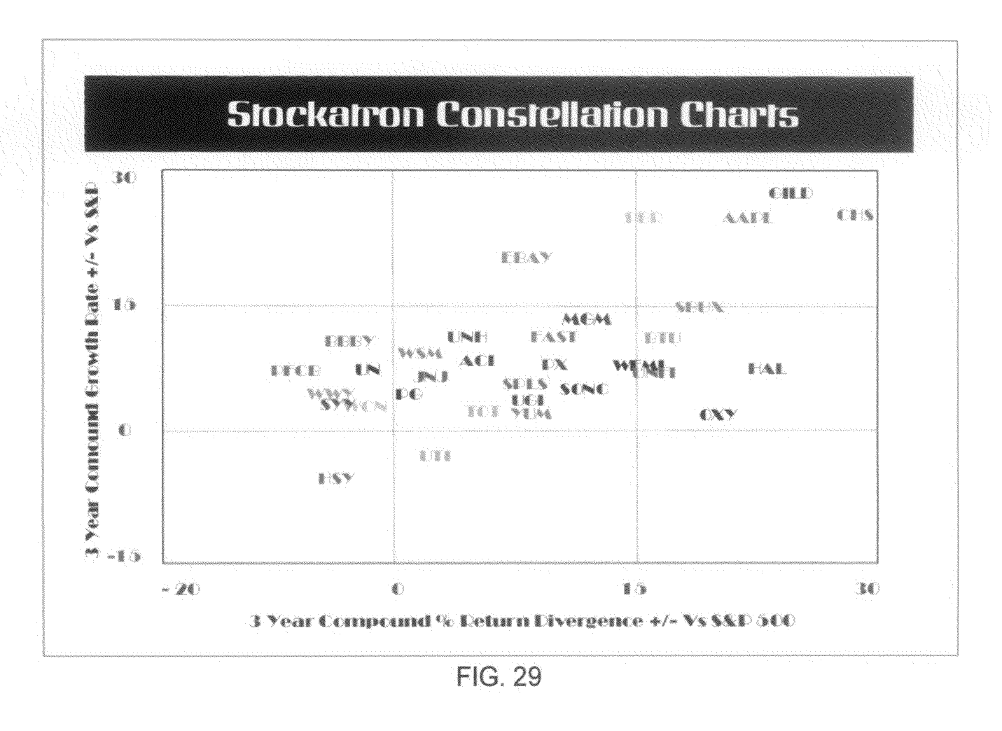

55. Commonly employed indexes, industry groups, mutual funds, individual portfolios or any synthetic blend of common stock can be stored in memory to be analyzed and illustrated on demand, in the same manner as any common stock, as shown in FIGS. 29-30.

56. Once the new indexes, mutual funds etc., are entered into memory and held as discrete files, a blend of blended securities can also be created. In other words, a user can employ the STOCKATRON INDEX AND MUTUAL FUND ANALYZER, and the STOCKALIZER PORTFOLIO tools to illustrate any combination of mutual funds, individual stocks, indexes, for portfolio rebalancing, “what if scenario” planning and portfolio selection purposes.

57. A distinctive new innovation feature outcome of the STOCKATRON AND STOCKALIZER MASTER blended index, mutual fund and portfolio analysis database information graphic visualization series is that now for the first time, investors can view the price performance, fundamental operating characteristics, valuation measures, and operating ratio characteristics of the composite collection of assets in their portfolio as if they were a single security employing all of the previously mentioned format and variable expression possibilities for the Stockalizer and Stockatron series of illustrations.

58. A particularly significant breakthrough feature achievement of the STOCKATRON AND STOCKALIZER master blended index, mutual fund and portfolio analysis database graphic visualization series, is that now for the first time, investors can clearly visualize how well their collective portfolios are performing compared to the major market indexes by viewing the illustrated composite price performance of their portfolio on an intraday, daily, weekly or other periodic basis when superimposed and compared to the major market indexes or any combination of commonly used performance comparison measures they wish to consider.

59. Another new truly significant advancement of the art achievement feature of the STOCKATRON AND STOCKALIZER master blended index, mutual fund and portfolio analysis database graphic visualization series is that now for the first time investors can view the composite progression and growth rate of the underlying fundamental operating characteristics of their portfolios, indexes, mutual funds, and professionally managed accounts to be able to estimate the theoretical +/− relative fair market value of the assets compared to the actual progression of price movement which has taken place over time.

Comparison with existing patented technology˜the STOCKATRON INDEX AND MUTUAL FUND ANALYZER, and the STOCKALIZER PORTFOLIO index series of combined data simulation stock market graphs, are uniquely new higher level expressions of an unheard of level of far more comprehensive financial data, and represent a historically new genre in documented synthetic stock market graph technology.

This comparison information has simply not been previously available, even in table form anywhere in the marketplace.

These are new function concepts, and there are no other “single graph˜dual axis horizontal line comparison graphs” (STOCKALIZER) or “single graph˜dual axis scattergram variable comparison charts” (STOCKATRON) in the marketplace which illustrate the correlation and interrelated progression of market valuation characteristics, stock performance measurements, and ongoing change of corporate operating results for an individual company, a universe of companies, or any synthetic blend of securities either by design or by function.

Because of perceived, stated and presumed difficulties combining the functions and utility of creating and updating a database of all publicly held companies, deriving and unifying data to a common scale and time period, perceived limitations of usefulness and deficiencies in the potential of current state of the art graphic design formats applicable to illustrating indexes, mutual fund and synthetic securities, current and previous state of the art index and mutual fund stock market comparison graphs are limited to text box descriptions and discussion, style and strategy illustration box charts, price movement only graphs of indexes and mutual funds, and simplistic price movement/standardized deviation performance comparisons of indexes, mutual funds, and professional money managers.

While one or more embodiments of the present invention have been illustrated in detail, the skilled artisan will appreciate that modifications and adoptions to those embodiments may be made without departing from the scope and spirit of the present invention as set forth in the following claims.

1. A computer implemented method for providing intuitive graphical illustrations on interrelated progression of stock movement and ongoing change of corporate financial results over a computer network, the method comprising the steps of:
providing at least one database maintaining separately stored fundamental data for each publicly traded company;
providing a server computer communicatively coupled to the database and accessible via client computers to a plurality of users;
providing a graphical user interface from which the user enters a request to the server computer;
processing the request;
delivering to the user a plurality of graphical illustrations in response to the request;
wherein the fundamental data being available to be juxtaposed and graphed via discreet progressions of dot points or by continuous lines via custom algorithms for creating synchronized streams of data, is calculated, stored and expressed in daily, weekly, monthly, quarterly and annual incremental periods as required for operations in accordance with the user's selection.

2. The method of claim 1, wherein said fundamental data is initially composed of publicly available data which is issued directly from the companies in quarterly 10Q and annual 10K SEC filings.

3. The method of claim 1, wherein said fundamental data is loaded and automatically updated via a linked remote access connection to an information service provider.

4. The method of claim 1, further comprising the steps of:
providing a means for automatically extracting updated data for each publicly traded company from all publicly available sources; and
providing a means for automatically updating the database.

5. The method of claim 1, wherein the step of processing the request further comprising the steps of:
extrapolating data required to synchronize variably expressed time periods such that data can be juxtaposed, manipulated, and viewed within a single scale graph for evaluation and illustration; and
linking interpolated data cells and files to computer generated custom combinations of formatted text, visualization tables and intuitive graphics.

6. The method of claim 5, wherein the step of processing the request further comprising the step of:
providing a means for juxtaposing and combining a plurality of combinations of stock market variables in a single two dimensional graph with a vertical measurement scale and horizontal scale for time period.

7. The method of claim 1, wherein the graphical illustrations comprises combinations of graphs and table charts.

8. The method of claim 1, wherein the graphical illustrations comprise high contrast color combinations and distinctive graphic symbol shapes to depict a variety of data within a single graph.

9. The method of claim 8, wherein the single graph depicts a plurality of variables which can be calculated and compared cumulatively over time, said variables comprising any of:
cumulative progressions of stock price movement,
earnings per share,
revenue,
cash flow,
net income,
debt,
ERBITDA, and
total equity.

10. The method of claim 9, wherein the single graph depicts year over year quarterly comparisons of operating variables juxtaposed and combined with a plurality of combinations of stock market fundamental, technical and stock price movement variables.

11. The method of claim 9, wherein the single graph depicts period over period comparisons of operating variables juxtaposed and combined with a plurality of combinations of stock market fundamental, technical and stock price movement variables.

12. The method of claim 8, wherein the single graph depicts historically usual repeating market cycle, the market cycle comprising:
an initial burst period;
a move consolidation phase; and
a draw down period of downward movement.

13. The method of claim 1, wherein said graphical illustrations comprise stock price movement horizontal box charts in which weekly price movement is expressed as discrete or overlapping progressions of boxes depicting open/high/low/close action and depicting market price close above or below an opening period price by color coding.

14. The method of claim 1, further comprising the step of:
providing a means for enabling the user to select or deselect custom combinations of data to be illustrated or view preformatted presets of graphically displayed data.

15. The method of claim 14, further comprising:
providing a means for enabling the user to select, add or subtract variables by clicking the variable label display.

16. The method of claim 15, further comprising:
providing a means for enabling the user to change the scaling of graphics to allow for different size and scale looks at the data by clicking on the graph scale.

17. The method of claim 1, further comprising:
providing a means for automatically linking a data base file for each publicly traded company to the data base files for all other publically traded companies; and
providing a means for synthesizing additional derived data to form the basis of a series of sorting, analytics, and custom graphic display and reporting output functions,
wherein the additional derived data is created via commonly available formulas and proprietary algorithms.

18. The method of claim 1, further comprising:
providing a means for extrapolating additional data required to synchronize variably expressed time periods; and
providing a means for unifying, juxtaposing, manipulating, and viewing the additional data within a common scale graph for evaluation and illustration.

19. The method of claim 18, wherein the at least one database comprises a means for linking interpolated data cells and files to computer generated custom combinations of formatted text, visualization tables and intuitive pattern recognition graphics for network computer terminal screen observation, evaluation, printing and file transfer capabilities.

20. The method of claim 1, wherein the graphical illustrations are scalable pursuant to the user's clicking on the graph scale.

21. The method of claim 1, wherein the graphical illustrations comprise a preformatted single page visualization summary of operating and performance characteristics.

22. The method of claim 1, wherein the graphical illustrations comprise a scatter gram chart depicting combinations of key operating and performance characteristics of any selected stock in the database.

23. The method of claim 22, wherein the graphical illustrations comprise relative value/performance characteristics charts depicting a plurality of combinations of relative value, stock performance, operating performance and technical stock analysis.

24. The method of claim 23, wherein the graphical illustrations comprise a two dimensional financial measurement comparison chart for measuring and comparing any two key operating and performance qualities of a plurality of companies.

25. The method of claim 1, further comprising:
providing a means for analyzing and illustrating synthetic combinations of securities.

26. The method of claim 25, further comprising:
providing a means for calculating pro-rata percentage contribution that each security plays in an index formation.

27. The method of claim 1, further comprising:
providing a means for integrating stock profile variable comparison with stock market movement comparison graph.

28. A computer implemented system for providing intuitive graphical illustrations on interrelated progression of stock movement and ongoing change of corporate financial results over a computer network, the system comprising:
at least one database maintaining separately stored fundamental data for each publicly traded company;
a server computer communicatively coupled to the database and accessible via client computers to a plurality of users;
a user's graphical interface from which the user enters a request to the server computer;
a processor for processing the user's request and delivering a plurality of graphical illustrations in response to the request;
wherein the fundamental data being available to be juxtaposed and graphed via discrete progressions of dot points or by continuous lines via custom algorithms for creating synchronized streams of data, is calculated, stored and expressed in daily, weekly, monthly, quarterly and annual incremental periods as required for operations in accordance with the user's selection.

29. The system of claim 28, wherein said fundamental data is initially composed of publicly available data which is issued directly from the companies in quarterly 10Q and annual 10K SEC filings.

30. The system of claim 28, wherein said fundamental data is loaded and automatically updated via a linked remote access connection to an information service provider.

31. The system of claim 28, further comprising:
a means for automatically extracting updated data for each publicly traded company from all publicly available sources; and
a means for automatically updating the database.

32. The system of claim 28, further comprising:
a means for extrapolating data required to synchronize variably expressed time periods such that data can be juxtaposed, manipulated, and viewed within a single scale graph for evaluation and illustration; and
a means for linking interpolated data cells and files to computer generated custom combinations of formatted text, visualization tables and intuitive graphics.

33. The system of claim 32, further comprising:
a means for juxtaposing and combining a plurality of combinations of stock market variables in a single two dimensional graph with a vertical measurement scale and horizontal scale for time period.

34. The system of claim 28, wherein the graphical illustrations comprises combinations of graphs and table charts.

35. The system of claim 28, wherein the graphical illustrations comprise high contrast color combinations and distinctive graphic symbol shapes to depict a variety of data within a single graph.

36. The system of claim 35, wherein the single graph depicts a plurality of variables which can be calculated and compared cumulatively over time, said variables comprising any of:
cumulative progressions of stock price movement,
earnings per share,
revenue,
cash flow,
net income,
debt,
ERBITDA, and
total equity.

37. The system of claim 36, wherein the single graph depicts year over year quarterly comparisons of operating variables juxtaposed and combined with a plurality of combinations of stock market fundamental, technical and stock price movement variables.

38. The system of claim 36, wherein the single graph depicts period over period comparisons of operating variables juxtaposed and combined with a plurality of combinations of stock market fundamental, technical and stock price movement variables.

39. The system of claim 36, wherein the single graph depicts historically usual repeating market cycle, the market cycle comprising:
an initial burst period;
a move consolidation phase; and
a draw down period of downward movement.

40. The system of claim 28, wherein said graphical illustrations comprise stock price movement horizontal box charts in which weekly price movement is expressed as discrete or overlapping progressions of boxes depicting open/high/low/close action and depicting market price close above or below an opening period price by color coding.

41. The system of claim 28, further comprising:
a means for enabling the user to select or deselect custom combinations of data to be illustrated or view preformatted presets of graphically displayed data.

42. The system of claim 41, further comprising:
a means for enabling the user to select, add or subtract variables by clicking the variable label display.

43. The system of claim 42, further comprising:
a means for enabling the user to change the scaling of graphics to allow for different size and scale looks at the data by clicking on the graph scale.

44. The system of claim 28, further comprising:
a means for automatically linking a data base file for each publicly traded company to the data base files for all other publically traded companies; and
a means for synthesizing additional derived data to form the basis of a series of sorting, analytics, and custom graphic display and reporting output functions,
wherein the additional derived data is created via commonly available formulas and proprietary algorithms.

45. The system of claim 28, further comprising:
a means for extrapolating additional data required to synchronize variably expressed time periods; and
a means for unifying, juxtaposing, manipulating, and viewing the additional data within a common scale graph for evaluation and illustration.

46. The system of claim 45, wherein the at least one database comprises a means for linking interpolated data cells and files to computer generated custom combinations of formatted text, visualization tables and intuitive pattern recognition graphics for network computer terminal screen observation, evaluation, printing and file transfer capabilities.

47. The system of claim 28, wherein the graphical illustrations are scalable pursuant to the user's clicking on the graph scale.

48. The system of claim 28, wherein the graphical illustrations comprise a preformatted single page visualization summary of operating and performance characteristics.

49. The system of claim 28, wherein the graphical illustrations comprise a scatter gram chart depicting combinations of key operating and performance characteristics of any selected stock in the database.

50. The system of claim 49, wherein the graphical illustrations comprise relative value/performance characteristics charts depicting a plurality of combinations of relative value, stock performance, operating performance and technical stock analysis.

51. The system of claim 50, wherein the graphical illustrations comprise a two dimensional financial measurement comparison chart for measuring and comparing any two key operating and performance qualities of a plurality of companies.

52. The system of claim 28, further comprising:
a means for analyzing and illustrating synthetic combinations of securities.

53. The system of claim 52, further comprising:
a means for calculating pro-rata percentage contribution that each security plays in an index formation.

54. The system of claim 53, further comprising:
a means for integrating stock profile variable comparison with stock market movement comparison graph.

55. A computer implemented system for providing intuitive graphs depicting stock market performance over a computer network, the system comprising:
at least one database maintaining separately stored fundamental data for each publicly traded company;
a server computer communicatively coupled to the database and accessible via client computers to a plurality of users;
a user's graphical interface from which the user enters a request to and receives a response from the server computer;
a processor for processing the user's request and delivering the response to the user;
wherein the fundamental data for each publicly traded company is calculated, stored and expressed in daily, weekly, monthly, quarterly and annual incremental periods as required by the user;
wherein the response comprises a single graph depicting interrelated progression of stock movement and primary and secondary corporate operating fundamentals and performance statistics; and
wherein the single graph comprises discrete progressions of data point and/or continuous lines.

56. The system of claim 55, wherein the fundamental data for each publicly traded company is initially composed of publicly available data which is issued directly from the standard filings of the companies in accordance with governmental rules and regulations.

57. The system of claim 55, wherein the fundamental data for each publicly traded company is manually entered and updated via keyboard entry.

58. The system of claim 55, wherein the fundamental data for each publicly traded company is loaded and automatically updated via a linked remote access database connection to information service providers.

59. The system of claim 55, further comprising a means to derive, calculate and store additional data into the fundamental data for each publicly traded company.

60. The system of claim 59, wherein the additional data is created via commonly available formulas.

61. The system of claim 59, wherein the additional data is created via custom algorithms.

62. The system of claim 55, wherein the fundamental data for each publicly traded company comprises data derived from estimates and projections, and Consensus Wall Street Opinion information entered and periodically updated via a linked subscription to remote access information service provider.

63. The system of claim 55, wherein the fundamental data for each publicly traded company comprises data derived from balance sheet and income statement information, plus price history, projections, ratios, derived technical and statistical measures, as well as consensus analyst opinions for the company.

64. The system of claim 55, wherein the at least one database comprises a first database which is arrayed and formatted for applying custom algorithms to extrapolate additional data required to synchronize variably expressed time periods.

65. The system of claim 64, wherein the data maintained in the first database can be juxtaposed, manipulated, and viewed within a single scale graph for evaluation and illustration.

67. The system of claim 65, wherein the data maintained in the first database is available to be juxtaposed and graphed via discreet progressions of dot points.

68. The system of claim 65, wherein the data maintained in the first database is available to be juxtaposed and graphed by continuous line representation via custom algorithms for creating synchronized streams of data.

69. The systems of claim 55, wherein the response comprises one or more stock market graphs, each of which using high contrast color combinations and distinctive graphic symbol shapes to depict a plurality of data categories.

70. The system of claim 64, wherein the first database comprises a means for arraying and arranging data for storage and calculation and for linking interpolated data cells and files to computer generated custom combinations of formatted text, visualization tables and intuitive pattern recognition graphics for network computer terminal screen observation, evaluation, printing and file transfer capabilities.

70. The system of claim 55, wherein the processor juxtaposes and combines a plurality of combinations of stock market fundamental, technical and stock price movement variables in a single two dimensional graph using a vertical measurement scale a horizontal scale for time period.

71. The systems of claim 69, wherein the plurality of data categories comprise: cumulative progressions of stock price movement, earnings per share, revenue, cash flow, net income, debt, ERBITDA, total equity.

72. The system of claim 55, wherein the response comprises year over year quarterly rates of change comparisons of operating variables juxtaposed and combined with a plurality of combinations of stock market fundamental, technical and stock price movement variables in a single two dimensional graph using a vertical measurement scale and a horizontal scale for time period.

73. The system of claim 55, wherein the response comprises a two dimensional graph depicting is a chronology of historical market movement for a long period of time.

74. The system of claim 55, wherein the response comprises compound rates of growth comparisons of operating variables juxtaposed and combined with numbers of combinations of stock market fundamental, technical, valuation and performance ratios, and stock price movement variables in a single two dimensional graph using a vertical measurement scale and a horizontal scale for time period.

75. The system of claim 55, wherein the response comprises year over year quarterly comparisons of dynamic range of stock price movement juxtaposed and combined with continuous price/150 day moving average, calendar year returns, monthly or quarterly open/high/low/close volatility, with the option to include additional combinations of fundamental, technical, valuation and performance ratios, and stock price movement variables in a single two dimensional graph using a vertical measurement scale and a horizontal scale for time period.

76. The system of claim 55, wherein the response comprises a stock price movement horizontal box chart for weekly price movement expressed as discrete or/and overlapping progressions of boxes illustrating open/high/low/close action and market price close above or below an opening period price by color coding.

77. The system of claim 55, further comprising:
a means for the user to select one or more pre-set combinations of variables; and
a means for the user to select custom combinations of variables;
a means for the user to deselect custom combinations of variables;
a means for the user to select a variable by clicking a first associated variable label display,
a means for the user to add a variable by clicking a second associated variable label display;
a means for the user to subtract a variable by clicking a third associated variable label display; and
a means for the user to change graphic scaling by clicking on a graph scale.

78. The system of claim 64, wherein the at least one database comprises a second database for linking each discrete individual company database file and for synthesizing additional data to form a basis of a series of sorting, analytics, and custom graphic display and reporting output functions.

79. The system of claim 78, wherein said second database is arrayed and formatted by applying custom algorithms for extrapolating additional data required to synchronize variably expressed time periods, wherein the additional data is unified, juxtaposed, manipulated, and viewed within a common scale graph for evaluation and illustration.

80. The system of claim 79, wherein the common scale graph comprises computer generated custom combinations of formatted text, visualization tables and intuitive pattern recognition graphics for network computer terminal screen observation, evaluation, printing, and file transfer capabilities.

81. The system of claim 55, wherein the response comprises:
a preformatted visualization single page summary of operating and performance characteristics of a stock market;
a table chart for abbreviated summary of a plurality of stocks;
a snapshot summary illustrating a plurality of variables of a company; and
a scatter gram chart depicting combinations of key operating and performance characteristics of a stock selected by the user.

82. The system of claim 55, wherein the response comprises a custom financial measurement comparison chart for measuring and comparing any two key operating and performance qualities of a plurality of companies.

83. The system of claim 78, wherein the at least one database comprises a third database for indexing, analyzing, and illustrating synthetic combinations of securities, the third database maintaining custom blended index file in response to the user's request.

84. The system of claim 83, wherein the custom blended index file is used to automatically update and re-calibrate the databases to reflect underlying fundamental and price movement changes taking place within the underlying elements in the user selected portfolio.
